(19) United States
(12) Patent Application Publication
(10) Pub. No.: US 2023/0204614 A1
(43) Pub. Date: Jun. 29, 2023

(54) DISPENSING SYSTEM, ROBOT, AND DISPENSING METHOD

(71) Applicants: KAWASAKI JUKOGYO KABUSHIKI KAISHA, Kobe-shi, Hyogo (JP); SYSMEX CORPORATION, Kobe-shi, Hyogo (JP)

(72) Inventors: Noboru TAKAGI, Kobe-shi (JP); Atsushi KAMEYAMA, Kobe-shi (JP); Eiji YOSHIKUWA, Kobe-shi (JP); Toshiyuki TSUJIMORI, Kobe-shi (JP); Shogo KUBOTA, Kobe-shi (JP); Satoshi OUCHI, Kobe-shi (JP); Yukio IWASAKI, Kobe-shi (JP); Yasuhiro KOUCHI, Kobe-shi (JP); Soichi OUE, Kobe-shi (JP); Hironori KOBAYASHI, Kobe-shi (JP); Yutaka MAEDA, Kobe-shi (JP); Takayuki KOSHIHARA, Kobe-shi (JP)

(73) Assignees: KAWASAKI JUKOGYO KABUSHIKI KAISHA, Kobe-shi, Hyogo (JP); SYSMEX CORPORATION, Kobe-shi, Hyogo (JP)

(21) Appl. No.: 18/000,012

(22) PCT Filed: May 27, 2021
(86) PCT No.: PCT/JP2021/020280

§ 371 Date: Nov. 28, 2022

(30) Foreign Application Priority Data
May 29, 2020 (JP) 2020-094830

(51) Int. Cl. G01N 35/10; B25J 9/00; G01N 35/00

(52) U.S. Cl. CPC G01N 35/10; B25J 9/0087; G01N 35/0099; G01N 35/00732; B25J 9/009; B25J 9/0096; G01N 2035/0405

(57) ABSTRACT

In a dispensing system, a body is arranged outside a specimen processing cabinet, and in a state where a hand and a dispenser are inserted into the specimen processing cabinets, a specimen accommodated in a specimen container held by the hand is dispensed into a dispensing container by the dispenser.

### TECHNICAL FIELD

This disclosure relates to a dispensing system, a robot and a dispensing method, and more particularly to a dispensing system, a robot, and a dispensing method for dispensing a specimen accommodated in a specimen container into a dispensing container inside a specimen processing cabinet.

### BACKGROUND ART

The global epidemic of COVID-19 has led to a sharp increase in demand for an infectious virus test. A typical example of the infectious virus test is a PCR test. In the PCR test, a pharyngeal swab of a patient is first collected with a cotton swab, and the cotton swab is stirred in a liquid in a specimen container to disperse a virus in the liquid. The specimen container is transported to a PCR testing facility. The liquid in the specimen container is transferred to a test container. Nucleic acid derived from the virus is extracted in the container, and the nucleic acid is amplified by PCR to diagnose positive/negative of virus infection in the patient. In the related art, in a work of dispensing a specimen into a test container for the infectious virus test, an inspection engineer sits in front of a safety cabinet and inserts his/her hand through a gap of a shutter provided in the safety cabinet and manually performs the test inside the safety cabinet. When the specimen dispensing work is performed manually, especially in a situation where the number of specimens increases and the inspection engineer continues to work alone for a long time, a work error due to human error may occur. Furthermore, since the inspection engineer handles infectious specimens, there is a problem that the risk of infection is high.

Various dispensing systems have been proposed in which a robot replaces the manual dispensing work performed in the safety cabinet. Such a dispensing system is disclosed in, for example, Japanese Unexamined Patent Application, First Publication No. 2017-51169.

Japanese Unexamined Patent Application, First Publication No. 2017-51169 discloses a dual-arm robot arranged inside a safety cabinet. In Japanese Unexamined Patent Application, First Publication No. 2017-51169, a workbench inside the safety cabinet is provided with instruments used by a dual-arm robot for specimen processing such as reagent injection, stirring, and cell scraping. Further, the dual-arm robot includes a base unit, a body, a right arm unit, and a left arm unit. The base unit is fixed to a floor inside the safety cabinet. Further, a lower end side of the body is fixed to the base unit, and the right arm unit and the left arm unit are provided on an upper end side. That is, in Japanese Unexamined Patent Application, First Publication No. 2017-51169, the entire dual-arm robot is arranged inside the safety cabinet. Then, inside the safety cabinet, the dual-arm robot holds a spatula by, for example, a robot hand provided on the right arm unit, and holds a culture vessel by a robot hand on the left arm unit. Then, the dual-arm robot performs an operation of scraping the cultured cells inside the culture vessel with the spatula by coordinating the right arm unit and the left arm unit. The dual-arm robot also injects a cell recovery solution into the culture vessel.

### CITATION LIST

### Patent Literature

[PTL 1] Japanese Unexamined Patent Application, First Publication No. 2017-51169

### SUMMARY OF INVENTION

In the system of Japanese Unexamined Patent Application, First Publication No. 2017-51169, since the safety cabinet itself is used as a work space dedicated to the robot, a cost associated with the introduction is large for the facility where the manual dispensing work is performed in the safety cabinet. For example, the safety cabinet that was used up to that point can no longer be used, and a workflow in a laboratory needs to be significantly changed when it is introduced. In addition, at an actual inspection site, specimen containers of the same standard do not always arrive, and specimen containers different from the normal standard may be dispensed. In such a case, since the safety cabinet of Japanese Unexamined Patent Application, First Publication No. 2017-51169 is a work space dedicated to the robot, when a specimen of a type that the robot cannot correspond arrives, as an irregular response, it is not possible to flexibly respond, such as the inspection engineer performing dispensing work in the safety cabinet instead of the robot. In addition, it can be assumed that the safety cabinet cannot be used during maintenance of the robot and the inspection cannot proceed.

This disclosure is made in order to solve the above-mentioned problems, and one purpose of this disclosure is to provide a dispensing system, a robot, and a dispensing method capable of being introduced at low cost and easily switched from a robot to an inspection engineer while reducing risks of human error and a worker infection by automating dispensing work of a specimen, which is conventionally performed manually in a safety cabinet, using the robot.

In order to achieve the above purpose, according to a first aspect of this disclosure, there is provided a dispensing system of individually dispensing a specimen accommodated in a specimen container into a dispensing container inside a specimen processing cabinet, the dispensing system including: a robot including a first robot arm provided with a hand for holding the specimen container, a second robot arm provided with a dispenser for dispensing the specimen accommodated in the specimen container into the dispensing container, and a body that supports the first robot arm and the second robot arm, in which at least the body of the robot is arranged outside the specimen processing cabinet, and in a state where the hand provided in the first robot arm and the dispenser provided in the second robot arm are inserted into the specimen processing cabinet, the dispenser dispenses the specimen accommodated in the specimen container held by the hand into the dispensing container. The body that supports the first robot arm and the second robot arm means one body that supports both the first robot arm and the second robot arm, and means a plurality of bodys that individually support the first robot arm and the second robot arm.

According to a second aspect of the disclosure, there is provided a robot individually dispensing a specimen accommodated in a specimen container into a dispensing container inside a specimen processing cabinet, the robot including: a first robot arm provided with a hand for holding the specimen container; a second robot arm provided with a dispenser for dispensing the specimen accommodated in the specimen container into the dispensing container; and a body that supports the first robot arm and the second robot arm, in which at least the body of the robot is arranged outside the specimen processing cabinet, and in a state where the hand provided in the first robot arm and the dispenser provided in the second robot arm are inserted into the specimen processing cabinet, the dispenser dispenses the specimen accommodated in the specimen container held by the hand into the dispensing container.

In the dispensing system according to the first aspect and the robot according to the second aspect of the disclosure, as described above, in the state where at least the body of the robot is arranged outside the specimen processing cabinet and the hand provided in the first robot arm and the dispenser provided in the second robot arm are inserted into the specimen processing cabinet, the dispenser dispenses the specimen accommodated in the specimen container held by the hand into the dispensing container. As a result, by simply arranging the robot adjacent to the specimen processing cabinet so that the hand of the first robot arm and the dispenser of the second robot arm are inserted into the specimen processing cabinet, it is possible to perform the dispensing work by the robot. For this reason, it is easy to replace the dispensing work, which is conventionally performed by an inspection engineer by inserting his/her hand into the specimen processing cabinet, with the robot. Since the existing specimen processing cabinet can be utilized, an introduction cost for the user can be suppressed. In addition, there is no need to significantly change a workflow associated with the dispensing work that is conventionally performed by the inspection engineer. Further, when the robot is installed inside the specimen processing cabinet, the dispensing work cannot be performed until the work is completed during maintenance of the robot. Meanwhile, in the dispensing system according to the first aspect and the robot according to the second aspect, by separating the hand of the first robot arm and the dispenser of the second robot arm of the robot from the specimen processing cabinet during the maintenance, that is, by separating the robot from the specimen processing cabinet, manual dispensing work can be performed instead of the robot. That is, it is possible to prevent the dispensing work from being delayed. In addition, even when it becomes necessary to process a specimen that cannot be handled in normal operation, such as a specimen container having a shape that does not fit a placing table, by separating the robot from the safety cabinet, the manual dispensing work can be performed. In this way, by automating the dispensing work of the specimen that is conventionally performed manually in the safety cabinet using a robot, it is possible to perform introduction at low cost and easily perform switching from the robot to the inspection engineer while reducing risks of human error and a worker infection.

According to the third aspect of the disclosure, there is provided a dispensing method of dispensing a specimen accommodated in a specimen container into a dispensing container by a hand of at least one robot arm inserted in a specimen processing cabinet, the dispensing method including: a step of holding the specimen container by the hand of the at least one robot arm; and a step of dispensing the specimen accommodated in the specimen container into the dispensing container by the hand of the at least one robot arm.

As described above, the dispensing method according to the third aspect of the disclosure includes the step of dispensing the specimen into the dispensing container by the hand of at least one robot arm inserted in the specimen processing cabinet. As a result, by simply arranging the robot adjacent to the specimen processing cabinet, it is possible to perform the dispensing work by the robot. Therefore, it is easy for the robot 10 to replace the dispensing work, which is conventionally performed by the inspection engineer by inserting his/her hand into the specimen processing cabinet. Since the existing specimen processing cabinet can be utilized, the introduction cost for the user can be suppressed. In addition, there is no need to significantly change a workflow associated with the dispensing work that is conventionally performed by the inspection engineer. Further, when the robot is installed inside the specimen processing cabinet, the dispensing work cannot be performed until the work is completed during maintenance of the robot. Meanwhile, in the dispensing method according to the third aspect, by separating the hand of the robot arm unit of the robot from the specimen processing cabinet during the maintenance, that is, by separating the robot from the specimen processing cabinet, manual dispensing work can be performed instead of the robot. That is, it is possible to prevent the dispensing work from being delayed. In addition, even when it becomes necessary to process a specimen that cannot be handled in normal operation, such as a specimen container having a shape that does not fit a placing table, by separating the robot from the safety cabinet, the manual dispensing work can be performed. In this way, by automating the dispensing work of the specimen that is conventionally performed manually in the safety cabinet using a robot, it is possible to perform introduction at low cost and easily perform switching from the robot to the inspection engineer while reducing risks of human error and a worker infection.

According to the present disclosure, as described above, it is possible to provide the dispensing system, the robot, and the dispensing method capable of being introduced at low cost and easily switched from the robot to the inspection engineer while reducing risks of the human error and the worker infection.

### BRIEF DESCRIPTION OF DRAWINGS

FIG. 1 is a view illustrating a building in which a dispensing system according to one embodiment of the present disclosure is arranged.

FIG. 2 is a top view of the dispensing system according to one embodiment of the present disclosure.

FIG. 3 is a side view of the dispensing system according to one embodiment of the present disclosure as viewed from an X1 direction side and a side view in which other parts are removed so that a hand of a first robot arm can be seen.

FIG. 4 is a side view of the dispensing system according to one embodiment of the present disclosure as viewed from the X1 direction side and a side view in which other parts are removed so that a dispenser of a second robot arm can be seen.

FIG. 5 is a top view of the hand of the first robot arm according to one embodiment of the present disclosure.

FIG. 6 is a side view of the hand of the first robot arm according to one embodiment of the present disclosure as viewed from the X1 direction side.

FIG. 7 is a view illustrating a microtube.

FIG. 8 is a side view of a dispensing operation as viewed from the X1 direction side.

FIG. 9 is a side view illustrating a lid opener/closer and an identification information reading unit according to one embodiment of the present disclosure as viewed from the X1 direction side.

FIG. 10 is a partially enlarged view of FIG. 9.

FIG. 11 is a side view illustrating a block according to one embodiment of the present disclosure as viewed from the X1 direction side.

FIG. 12 is a view illustrating an operation of closing a lid unit of the microtube.

FIG. 13 is a view illustrating a control block of the dispensing system according to one embodiment of the present disclosure.

FIG. 14 is a flow chart for explaining a work of an operator before the dispensing operation.

FIG. 15 is a flow chart for explaining an operation of a control communication unit of a command unit according to one embodiment of the present disclosure.

FIG. 16 is a flow chart for explaining the operation of the control communication unit of the robot according to one embodiment of the present disclosure.

FIG. 17 is a flow chart for explaining an operation of holding a specimen container and the microtube.

FIG. 18 is a flow chart for explaining an operation of reading identification information and opening the specimen container.

FIG. 19 is a flow chart for explaining the dispensing work.

FIG. 20 is a flow chart for explaining an operation of closing the specimen container.

FIG. 21 is a flow chart for explaining the work of the operator after the dispensing operation.

FIG. 22 is a view illustrating a plate as a dispensing container according to a modification example.

FIG. 23 is a view illustrating a state in which a cover member is placed on a plate as a dispensing container according to a modification example.

FIG. 24 is a dispensing system according to a modification example, and is a view illustrating a state in which a first robot arm and a second robot arm are inserted into a safety cabinet.

### DESCRIPTION OF EMBODIMENTS

Hereinafter, one embodiment of the present disclosure embodying the present disclosure will be described with reference to the drawings.

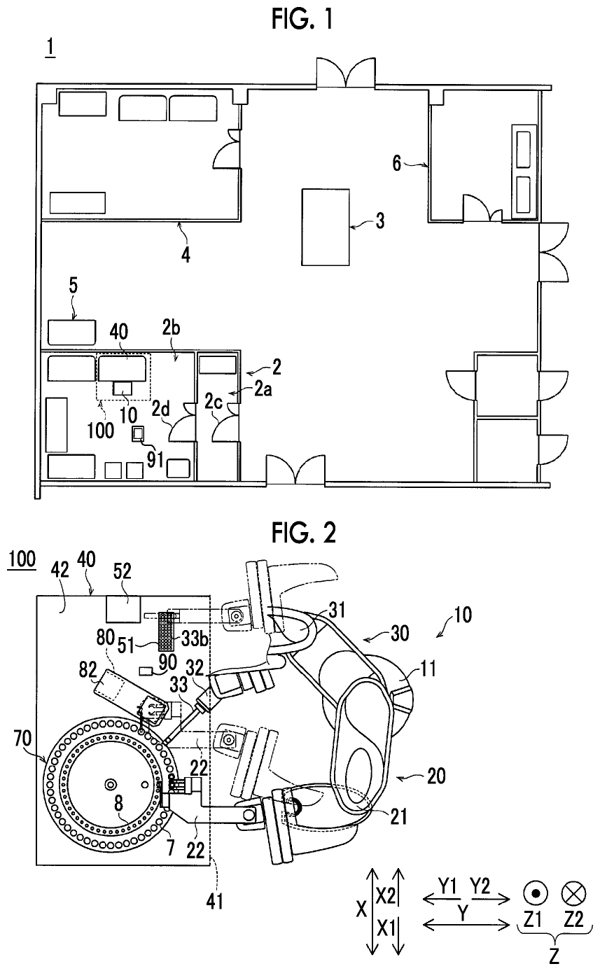

A configuration of a dispensing system 100 according to the present embodiment will be described with reference to FIGS. 1 to 13. The dispensing system 100 of the present embodiment is for dispensing a specimen accommodated in a specimen container into a test container, or a microtube in the present embodiment, as a pretreatment for a RT-PCR test of an infectious virus. The dispensing system 100 of the present embodiment is particularly effective when applied to a work of dispensing a specimen containing infectious viruses associated with the risk of infection due to airborne infection or droplet infection in a case where an inspection engineer opens the specimen container and performs dispensing with a pipette. The infectious virus is not particularly limited, but COVID-19 is an example.

(Structure of Building)

First, with reference to FIG. 1, a building 1 in which the dispensing system 100 is arranged will be described. As illustrated in FIG. 1, a room 2 is provided inside the building 1 for receiving a specimen used for the PCR test and performing a pretreatment step for the RT-PCR test. The room 2 is a negative pressure room having a lower pressure than the outside. The room 2 includes partitioned portions 2a and 2b. A door portion 2c is provided in the portion 2a, and the specimen is received via the door portion 2c. Further, a door portion 2d is provided between the portion 2a and the portion 2b. The specimen received via the door portion 2c is carried into the portion 2b via the door portion 2d. In this embodiment, the dispensing system 100 is arranged in the portion 2b of the negative pressure room 2. Then, a specimen container 7 in which the specimen is accommodated is supplied into the portion 2b from the outside of the room 2. The room 2 is an example of a work room. The PCR test is an example of a test for infectious diseases.

Further, a workbench 3 for extracting nucleic acid is arranged in a central portion of the inside of the building 1.

Further, a room 4 for preparing a PCR reaction solution using the extracted nucleic acid is provided inside the building 1. The room 4 is a positive pressure room having a higher pressure than the outside.

Further, a safety cabinet 5 for adding a positive control to a PCR reaction plate is arranged inside the building 1.

Further, a room 6 in which PCR is amplified and detected is provided inside the building 1. The room 6 is a negative pressure room having a lower pressure than the outside.

(Dispensing System)

Next, the dispensing system 100 will be described. The dispensing system 100 automates the pretreatment step of the RT-PCR test for the infectious virus. As illustrated in FIGS. 2 to 4, the dispensing system 100 includes a robot 10. In the present embodiment, the robot 10 of the dispensing system 100 is arranged so that a hand 22 and a dispenser 33 attached to a tip of a robot arm are inserted into the safety cabinet 40, and uses the robot arm to dispense the specimen used for the PCR test accommodated in the specimen container 7 into a microtube 8 as the pretreatment for the PCR test. Further, the specimen is accommodated inside the specimen container 7, and the specimen contains an inactivated virus. The safety cabinet 40 is an example of a specimen processing cabinet. The microtube 8 is an example of a dispensing container.

As illustrated in FIGS. 2 to 4, the robot 10 includes a dual-arm horizontal articulated robot including a first robot arm 20, a second robot arm 30, and a body 11. The body 11 supports both the first robot arm 20 and the second robot arm 30. Each of the first robot arm 20 and the second robot arm 30 includes a plurality of link members 21 and a plurality of link members 31. Each of the first robot arm 20 and the second robot arm 30 is an example of a robot arm unit.

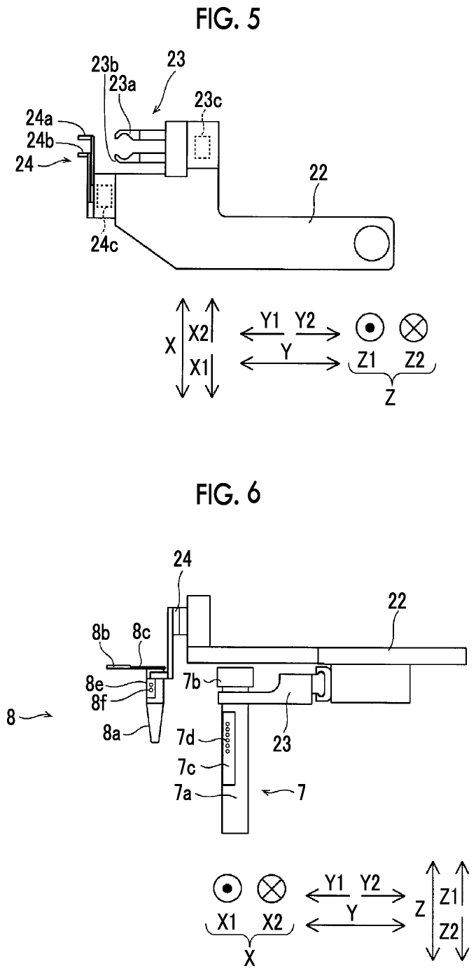

The first robot arm 20 is provided with a hand 22 for holding the specimen container 7 in which the specimen is accommodated and the microtube 8 into which the specimen is dispensed. Specifically, as illustrated in FIGS. 5 and 6, the hand 22 of the first robot arm 20 includes a first chuck 23 that holds the specimen container 7 and a second chuck 24 that holds the microtube 8.

The first chuck 23 includes a pair of support pieces 23a and 23b, and a motor 23c that moves the support pieces 23a toward the support pieces 23b. The first chuck 23 moves the support piece 23a by driving the motor 23c according to control of a control communication unit 10a, which will be described later, in a state where the specimen container 7 is between the pair of support pieces 23a and 23b, and holds the specimen container 7 by narrowing a distance between the support piece 23a and the support piece 23b. When the pair of support pieces 23a and 23b are brought closer to a predetermined distance by driving the motor 23c, the control communication unit 10a described later determines that the specimen container 7 does not exist at a corresponding position of a placing table 70.

The second chuck 24 includes a pair of support pieces 24a and 24b, and a motor 24c that moves the support pieces 24a toward the support pieces 24b. The second chuck 24 moves the support piece 24a by driving the motor 24c according to the control of the control communication unit 10a, which will be described later, in a state where the microtube 8 is between the pair of support pieces 24a and 24b, and holds the microtube 8 by narrowing a distance between the support piece 24a and the support piece 24b. When the pair of support pieces 24a and 24b are brought closer to a predetermined distance by driving the motor 24c, the control communication unit 10a described later determines that the microtube 8 does not exist at a corresponding position of the placing table 70.

The hand 22 of the first robot arm 20 is constituted by a plate member having a substantially L shape in a plan view. The first chuck 23 and a second chuck 24 are provided at a tip portion of the plate member having a substantially L shape. The first chuck 23 and the second chuck 24 are arranged to be separated from each other. A distance between the first chuck 23 and the second chuck 24 is adjusted to correspond to a distance between the specimen container 7 and the microtube 8 arranged in advance on the placing table 70 having a disk shape described later.

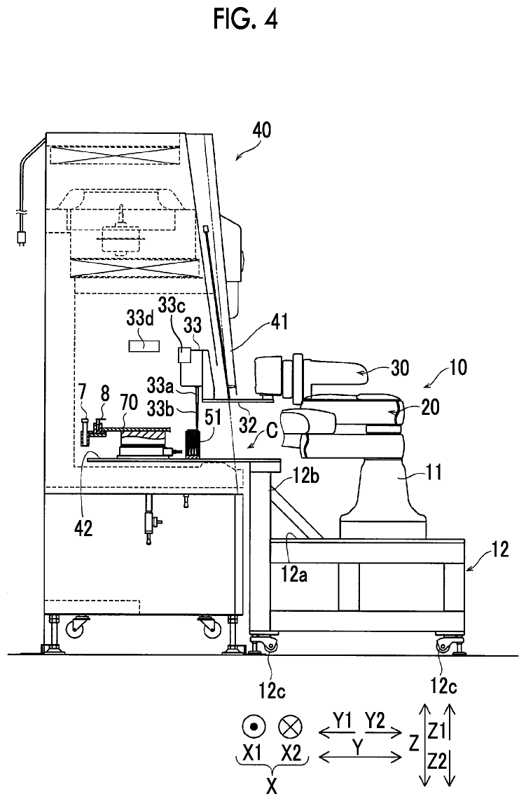

As illustrated in FIG. 4, the hand 32 of the second robot arm 30 is provided with a dispenser 33 that dispenses the specimen accommodated in the specimen container 7 into the microtube 8 into which the specimen is dispensed. The dispenser 33 includes a pipette 33a for sucking and discharging the specimen accommodated in the specimen container 7, and a dispensing tip 33b attached to a tip of the pipette 33a. The hand 32 has a substantially L shape that extends horizontally from the second robot arm 30 and is bent upward. By the second robot arm 30, the pipette 33a and the dispensing tip 33b move in the up-down direction together with the hand 32 which is bent upward and has a substantially L shape.

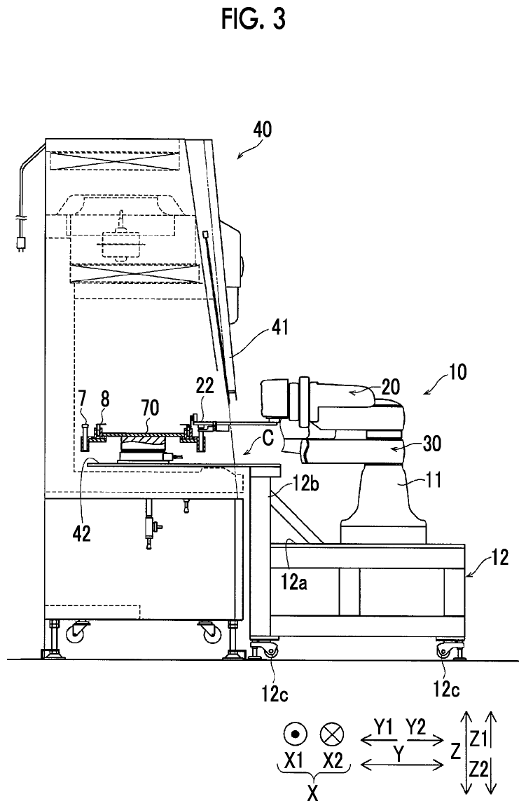

As illustrated in FIGS. 3 and 4, the body 11 supports the first robot arm 20 and the second robot arm 30. Specifically, the first robot arm 20 is arranged above, and the second robot arm 30 is arranged below.

As illustrated in FIG. 6, the specimen container 7 includes a main body 7a in which the specimen is accommodated and a screw cap 7b that covers an opening of the main body 7a. The screw cap 7b is attached to or removed from the main body 7a by rotating the screw cap 7b with respect to the main body 7a. Further, the specimen container 7 accommodates a solution for inactivating the specimen, for example, hypochlorite or alcohol. Further, an identification information label 7c is attached to the specimen container 7. The identification information label 7c is printed with unique identification information 7d that specifies the specimen accommodated in the specimen container 7. The identification information 7d is, in one example, a specimen number. The identification information 7d is preferably a machine-readable code. The code may be a one-dimensional bar code or a two-dimensional code. The identification information 7d may be machine- and human-readable information, or may be numbers, letters, symbols, or a combination thereof. The identification information label 7c may be a non-contact IC tag in which the identification information 7d is stored. The identification information 7d is a machine-readable barcode in the present embodiment. The main body 7a and the screw cap 7b are examples of a specimen container main body and a specimen container lid, respectively.

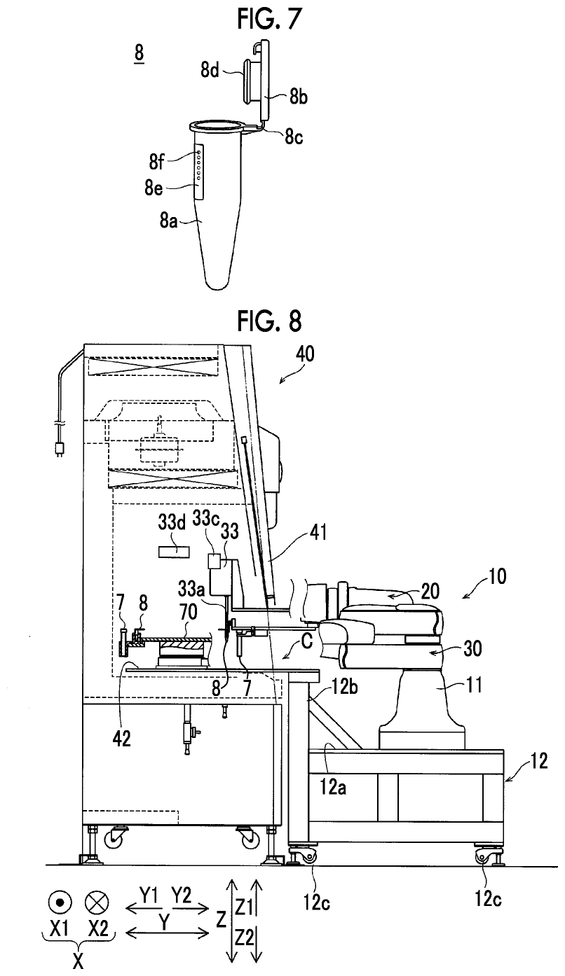

As illustrated in FIG. 7, the microtube 8 includes a main body 8a into which the specimen is dispensed, and a lid unit 8b connected to the main body 8a via a connector 8c. The lid unit 8b is provided with an insertion unit 8d to be inserted into the main body 8a, and the insertion unit 8d of the lid unit 8b is inserted into the main body 8a to close an opening of the main body 8a. Further, an identification information label 8e is attached to the microtube 8. Unique identification information 8f for specifying the microtube 8 is printed on the identification information label 8e. The identification information 8f is, in one example, a serial number assigned to each microtube. The identification information 8f is preferably a machine-readable code. The code may be a one-dimensional bar code or a two-dimensional code. The identification information 8f may be machine- and human-readable information, or may be numbers, letters, symbols, or a combination thereof. The identification information 8f is a machine-readable barcode in the present embodiment. The identification information label 8e may be a non-contact IC tag in which the identification information 8f is stored. The main body 8a and the lid unit 8b are examples of a dispensing container main body and a dispensing container lid, respectively.

As illustrated in FIG. 8, a work of dispensing the specimen accommodated in the specimen container 7 into the microtube 8 is performed inside the safety cabinet 40. The safety cabinet 40 includes a transparent shutter unit 41 provided on the front side. Further, a workbench 42 on which the specimen container 7 and the like are placed is arranged inside the safety cabinet 40. A gap C is provided between the shutter unit 41 and the workbench 42. An internal space surrounded by the shutter unit 41 and the workbench 42 is adjusted to a negative pressure. The negative pressure means a negative-pressure. This prevents air that has come into contact with the specimen in the specimen container 7 or the specimen dispensed into the microtube 8 from leaking from the gap C while allowing the hand 22 of the first robot arm 20 and the dispenser 33 of the second robot arm 30 to work in the safety cabinet 40 from the gap C.

Further, in the present embodiment, a base 12 on which the robot 10 is placed is provided. The workbench 42, which is arranged in the safety cabinet 40 and on which the specimen container 7 is placed, and the base 12 are integrally configured. Specifically, a base unit 12a on which the body 11 of the robot 10 of the base 12 is placed and the workbench 42 are connected by a connection portion 12b extending in an up-down direction. Further, the workbench 42 and the base unit 12a are configured in a stepped shape.

As illustrated in FIGS. 3 and 4, the base 12 is provided with casters 12c. In the case of failure or maintenance of the robot 10, the robot 10 can be separated from the safety cabinet 40 by moving the base 12 by the casters 12c. As a result, the inspection engineer can manually continue the dispensing work instead of the robot 10 by using the safety cabinet 40 as a work space.

Here, in the present embodiment, in a state where at least the body 11 of the robot 10 is arranged outside the safety cabinet 40 and the hand 22 provided in the first robot arm 20 and the dispenser 33 provided in and the second robot arm 30 are inserted into the safety cabinet 40, the dispenser 33 dispenses the specimen accommodated in the specimen container 7 held by the hand 22 into the microtube 8. Specifically, the first robot arm 20, the second robot arm 30, and the body 11 are arranged outside the shutter unit 41 of the safety cabinet 40. Then, the hand 22 of the first robot arm 20, the hand 32 of the second robot arm 30, and the dispenser 33 are inserted into the safety cabinet 40 from the gap C between the shutter unit 41 and the workbench 42.

Specifically, in the present embodiment, as illustrated in FIG. 8, inside the safety cabinet 40, the dispenser 33 dispenses the specimen accommodated in the specimen container 7 held by the first chuck 23 of the hand 22 into the microtube 8 held by the second chuck 24.

Further, in the present embodiment, as illustrated in FIG. 4, the dispenser 33 has the pipette 33a for sucking and discharging the specimen accommodated in the specimen container 7, and a dispensing tip rack 51 on which a plurality of the dispensing tips 33b attached to the tip of the pipette 33a are placed is provided. The dispensing tip rack 51 is arranged inside the safety cabinet 40. The second robot arm 30 attaches the dispensing tip 33b to the pipette 33a by lowering the pipette 33a of the dispenser 33 toward the dispensing tip 33b placed on the dispensing tip rack 51.

Further, in the present embodiment, as illustrated in FIG. 2, a dispensing tip disposal unit 52 in which the dispensing tip 33b is discarded is provided. The dispensing tip disposal unit 52 is arranged inside the safety cabinet 40. The second robot arm 30 moves the dispenser 33 with the dispensing tip 33b attached above the dispensing tip disposal unit 52, removes the dispensing tip 33b from the pipette 33a, and discards the dispensing tip in the dispensing tip disposal unit 52. Specifically, the dispenser 33 is provided with a tip ejector 33c for removing the dispensing tip 33b from the pipette 33a on an upper portion of the dispenser 33. After the dispensing of one specimen is completed, the dispenser 33 with the dispensing tip 33b attached is moved above the dispensing tip disposal unit 52 by the second robot arm 30, the tip ejector 33c of the second robot arm 30 abuts on a block 33d provided in the safety cabinet 40, and thus, the dispensing tip 33b is removed from the pipette 33a and discarded by the dispensing tip disposal unit 52. An example of the tip ejector 33c and a method for separating a dispensing tip using the tip ejector 33c is described in United States Patent No. 2019-0195901, and the entire disclosure contents are incorporated herein by reference.

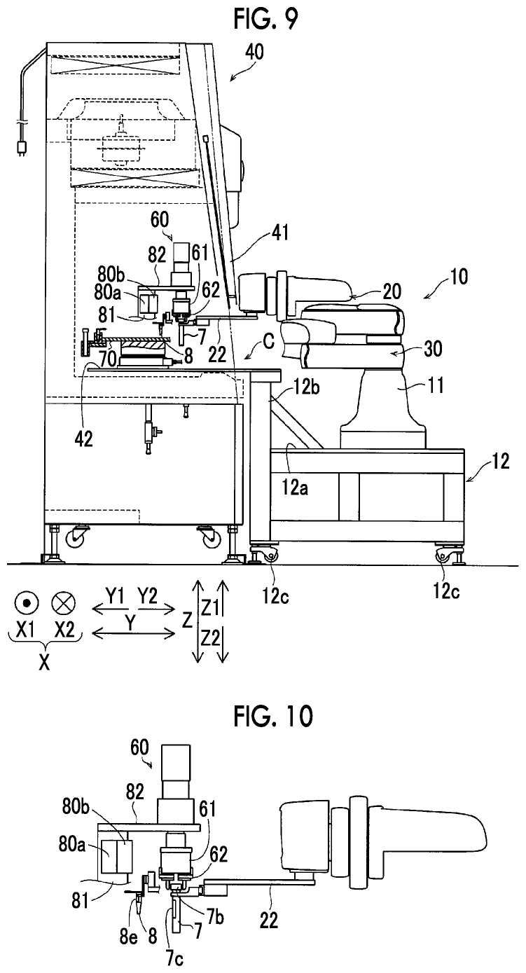

Further, as illustrated in FIG. 9, the dispensing system 100 of the present embodiment performs an operation of opening the screw cap 7b of the specimen container 7 inside the safety cabinet 40. Specifically, the dispensing system 100 includes a lid opener/closer 60 arranged inside the safety cabinet 40. Then, the lid opener/closer 60 opens or closes the screw cap 7b of the specimen container 7 in a state where the main body 7a is held by the hand 22 of the first robot arm 20, in cooperation with the hand 22 of the first robot arm 20.

In the present embodiment, the lid opener/closer 60 includes a holding rotator 61 that holds and rotates the screw cap 7b. The holding rotator 61 includes a plurality of claw portions 62 for holding the screw cap 7b. Then, while the holding rotator 61 holds and rotates the screw cap 7b, the hand 22 of the first robot arm 20 moves downward to be separated from the holding rotator 61, and thus, the screw cap 7b is removed from the main body 7a. The removed screw cap 7b is held by the holding rotator 61 during the dispensing work.

Further, in the present embodiment, an operation of closing the opened screw cap 7b of the specimen container 7 is performed inside the safety cabinet 40. Specifically, the first robot arm 20 moves the main body 7a of the specimen container 7 after the dispensing to a position in contact with a lower end of the screw cap 7b held by the holding rotator 61. Then, while the holding rotator 61 holds and rotates the screw cap 7b, the hand 22 of the first robot arm 20 moves upward to approach the holding rotator 61, and thus, the screw cap 7b is attached to the main body 7a.

Further, in the present embodiment, as illustrated in FIG. 2, a plurality of the specimen containers 7 are provided. The dispensing system 100 of the present embodiment is arranged inside the safety cabinet 40, and includes the rotatable placing table 70 having a disk shape on which at least the plurality of specimen containers 7 are placed in a circumferential shape. In this embodiment, a plurality of the microtubes 8 are also provided. Both the plurality of specimen containers 7 and the plurality of microtubes 8 are placed on the placing table 70 having a disk shape in a circumferential shape. The plurality of specimen containers 7 and the plurality of microtubes 8 are provided in the same number. Further, the specimen container 7 is arranged on an outer diameter side of the placing table 70, and the microtube 8 is arranged on an inner diameter side thereof. The specimen container 7 and the microtube 8 are arranged along a radial direction of the placing table 70 having a disk shape.

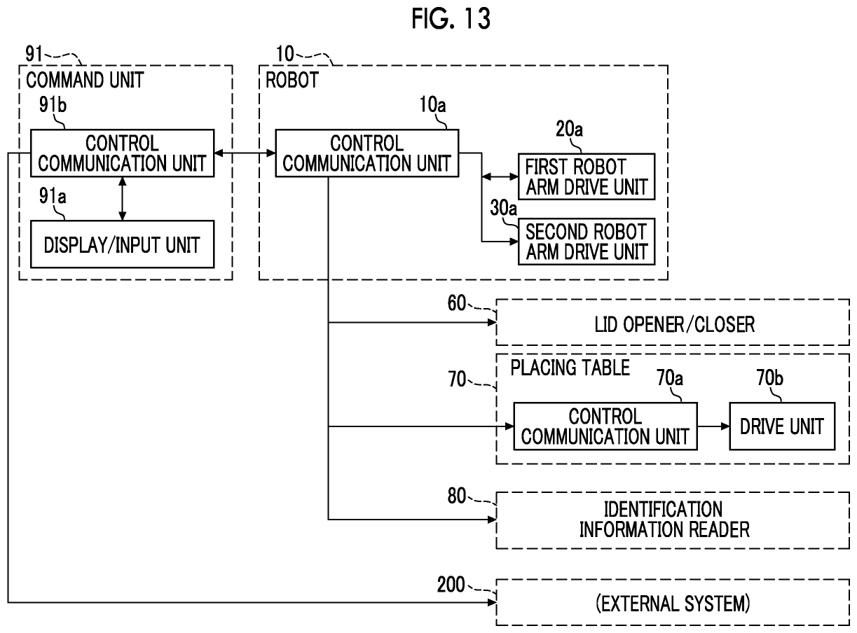

As illustrated in FIG. 13, the placing table 70 having a disk shape includes the control communication unit 70a and a drive unit 70b. The control communication unit 70a is, for example, a programmable logic controller (PLC). The drive unit 70b is, for example, a stepping motor. The placing table 70 is rotated by a predetermined angle by the drive unit 70b based on a command from a command unit 91 input via the control communication unit 70a. Further, the predetermined angle to be rotated is one pitch of the specimen container 7 placed on the placing table 70 in a circumferential shape. One pitch is 360 degrees/number of specimen containers 7. Then, by rotating the placing table 70, the specimen container 7 and the microtube 8 to be dispensed next are moved to the vicinity of the hand 22 of the first robot arm 20.

Further, in the present embodiment, as illustrated in FIGS. 9 and 10, an identification information reading unit 80 is provided. The identification information reading unit 80 includes identification information reading units 80a and 80b. The identification information reading units 80a and 80b are, in one example, a reflection type barcode reader, and read the barcode by irradiating the barcode with a laser beam and detecting the reflected light by a sensor. The identification information reading units 80a and 80b are not limited to barcode readers, but may be cameras or non-contact IC readers. The identification information reading unit 80 is arranged inside the safety cabinet 40. The identification information reading unit 80a reads the identification information 7d from the identification information label 7c attached to the specimen container 7 held by the lid opener/closer 60. Specifically, as will be described later, after the first robot arm 20 causes the lid opener/closer 60 to hold the specimen container 7, the first robot arm 20 separates from the specimen container 7, and the lid opener/closer 60 rotates the specimen container 7 in the meantime. The identification information reading unit 80a reads the identification information 7d from the identification information label 7c of the rotating specimen container 7. By reading the identification information while rotating the specimen container 7, even when the barcode label has cuts or stains, reading from a different angle increases the probability of successful reading. The identification information reading units 80a and 80b are examples of the first identification information reader and the second identification information reader, respectively. Further, the identification information 7d is an example of first identification information in claims.

In the identification information reading unit 80b, the hand 22 of the first robot arm 20 moves the microtube 8 held by the hand 22 to the vicinity of the identification information reading unit 80b which is a position at which the identification information reading unit 80b can read the identification information 80e, and thus, the identification information reading unit 80b reads the identification information 8f from the identification information label 8e attached to the microtube 8. The reading of the identification information 7d of the specimen container 7 and the reading of the identification information 8f of the microtube 8 are performed at the same time. Then, the identification information 7d of the specimen container 7 and the identification information 8f of the microtube 8 are sent to the control communication unit 91b of the command unit 91 via the control communication unit 10a of the robot 10, and are transmitted to an external system 200 illustrated in FIG. 13 from the control communication unit 91b. The external system 200 is, for example, a clinical test information system that integrates and manages test results in a laboratory. In the external system 200, the test result after the PCR test is associated with the identification information 7d of the specimen container 7 and the identification information 8f of the microtube 8. The identification information reading units 80a and 80b are arranged to be adjacent to each other. Further, a partition may be provided between the identification information reading unit 80a and the identification information reading unit 80b. Further, the identification information 8f is an example of second identification information.

Further, the identification information reading unit 80 is arranged in the vicinity of the lid opener/closer 60. The identification information reading unit 80a reads the identification information 7d from the identification information label 7c attached to the specimen container 7 in a state where the main body 7a is held by the first chuck 23 of the hand 22 and the screw cap 7b is held by the holding rotator 61 of the lid opener/closer 60. The identification information reading unit 80 is fixed to a pillar portion 81 extending in the up-down direction. A plate portion 82 is connected to an upper end of the pillar portion 81, and the lid opener/closer 60 is connected to a lower surface of the plate portion 82.

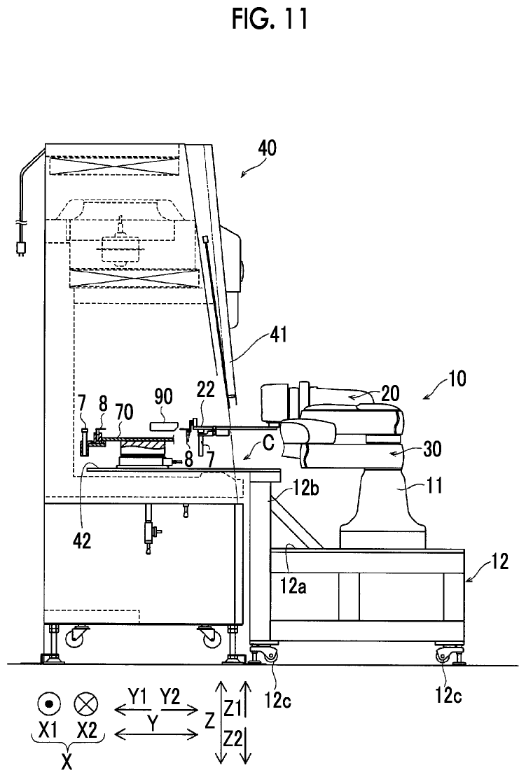

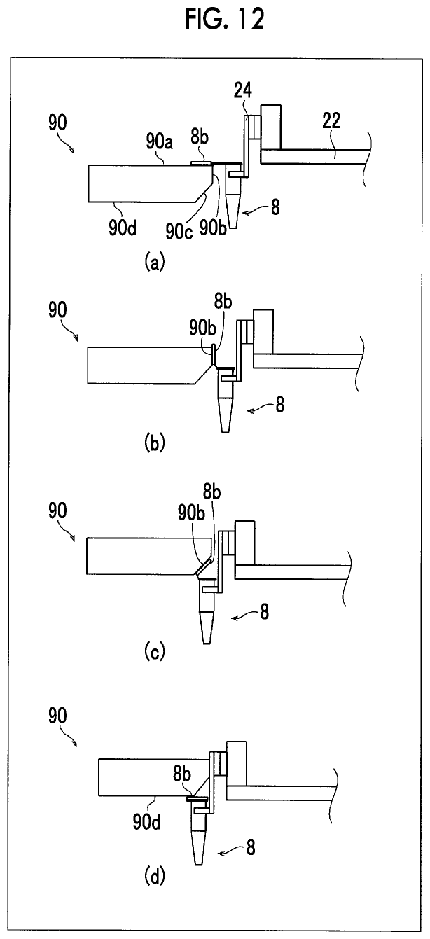

Further, in the present embodiment, as illustrated in FIG. 11, an operation of closing the lid unit 8b of the microtube 8 after the specimen accommodated in the specimen container 7 is dispensed is performed inside the safety cabinet 40. A block 90 which closes the lid unit 8b of the microtube 8 after the specimen accommodated in the specimen container 7 is dispensed in cooperation with the hand 22 of the first robot arm 20 is arranged inside the safety cabinet 40. As illustrated in FIG. 12, the lid unit 8b of the microtube 8 abuts on the block 90. Then, the microtube 8 is relatively moved with respect to the block 90 by the first robot arm 20, the lid unit 8b connected to the microtube 8 via the connector 8c abuts on an upper surface 90a, a side surface 90b, an inclined surface 90c, and a lower surface 90d of the block 90, and thus, the lid unit 8b is closed. The block 90 is an example of a lid closer. Further, the upper surface 90a, the side surface 90b, the inclined surface 90c, and the lower surface 90d are examples of an abutment portion.

Specifically, as illustrated in FIG. 12(a), the first robot arm 20 moves the lid unit 8b of the microtube 8 so that the lid unit 8b is placed on the upper surface 90a of the block 90. Then, as illustrated in FIG. 12(b), the microtube 8 is moved downward by the first robot arm 20. As a result, the lid unit 8b of the microtube 8 is arranged in the up-down direction along the side surface 90b of the block 90. Further, as illustrated in FIG. 12(c), the microtube 8 is moved diagonally downward, and thus, the lid unit 8b of the microtube 8 is moved to approach an opening portion of the main body 8a along the inclined surface 90c of the block 90. Further, as illustrated in FIG. 12(d), the microtube 8 is moved diagonally downward, and thus, the lid unit 8b of the microtube 8 is moved along the lower surface 90d of the block 90, and the opening portion of the main body 8a is closed by the lid unit 8b.

Further, in the present embodiment, as illustrated in FIG. 1, the command unit 91 for receiving an operation for commanding the start of the dispensing work by the robot 10 is arranged outside the safety cabinet 40. The command unit 91 is, for example, a computer having a display/input unit 91a illustrated in FIG. 13, and as an example, includes a tablet terminal or a Graphic Order Terminal (GOT). Further, the command unit 91 is arranged in the room 2. The display/input unit 91a displays a screen for operation and accepts input by a worker.

FIG. 13 is a control block view of the dispensing system 100 of the present embodiment. In the drawing, arrows indicate communication paths between components. As illustrated in FIG. 13, the command unit 91 includes the control communication unit 91b. The control communication unit 91b is, for example, a CPU provided in the computer. The robot 10 includes the control communication unit 10a. The control communication unit 10a is, for example, a CPU provided inside the robot. The command unit 91 communicates with the control communication unit 10a of the robot 10 via the control communication unit 91b. Then, the command unit 91 transmits a command via the control communication unit 10a of the robot 10 to control a first robot arm drive unit 20a of the first robot arm 20 and a second robot arm drive unit 30a of the second robot arm 30. The control communication unit 10a of the robot 10 transmits an operation instruction signal to the first robot arm 20 and the second robot arm 30 and receives feedback signals from the servomotors included in the plurality of link members 21 and 31 to control the operation of each robot arm unit. Further, the control communication unit 10a of the robot 10 controls the operations of the hand 22 of the first robot arm 20 and the dispenser 33 of the second robot arm 30 by transmitting the operation signal and receiving the feedback signal via each robot arm unit. Further, the control communication unit 10a of the robot 10 transmits a reading instruction signal to the identification information reading unit 80, and receives the identification information 7d and 8f read by the identification information 80. Further, the control communication unit 10a of the robot 10 controls the operation of the placing table 70 by transmitting the operation instruction signal to the control communication unit 70a of the placing table 70. Further, the control communication unit 10a of the robot 10 controls the operations of the holding rotator 61 and the claw portion 62 by transmitting the operation instruction signal to the lid opener/closer 60.

(Dispensing Method)

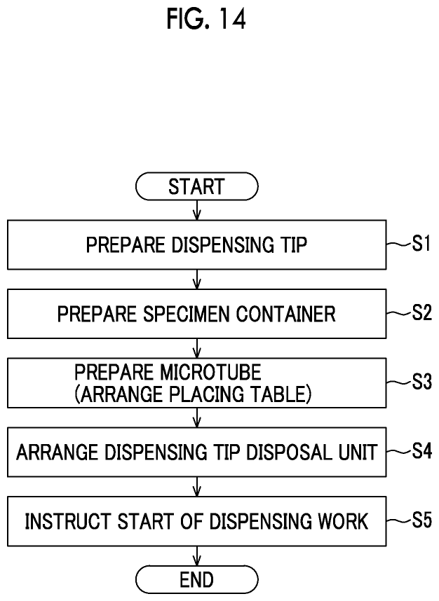

Next, a method of dispensing the specimen accommodated in the specimen container 7 will be described. First, with reference to FIG. 14, the work of the operator before the dispensing operation by the dispensing system 100 will be described.

In Step S1, the operator sets the dispensing tip 33b in the dispensing tip rack 51, and places the dispensing tip rack 51 in which the dispensing tip 33b is set on the workbench 42 inside the safety cabinet 40.

In Step S2, the operator accepts a plurality of specimen containers 7. Further, the operator attaches the identification information label 7c to each of the plurality of received specimen containers 7. In addition, the attached state of the identification information label 7c attached to each of the received plurality of specimen containers 7 is confirmed. After confirming the attached state of the identification information label 7c, the specimen container 7 is set in the heating block and heated in order to inactivate the virus in the specimen. After that, the plurality of specimen containers 7 are placed on the placing table 70. The inactivation may be immediately after receiving the plurality of specimen containers 7, or the identification information label 7c may be attached in advance before the plurality of specimen containers 7 are received.

In Step S3, the operator attaches the identification information label 8e to each of the plurality of microtubes 8. Further, the operator confirms the attached states of the identification information labels 8e attached to the plurality of microtubes 8, and after the confirmation, places the plurality of microtubes 8 on the placing table 70. In Steps S2 and S3, the operator places the specimen container 7 and the microtube 8 on the placing table 70 in a state where the positions of the specimen container 7 and the microtube 8 are adjusted so that the identification information 7d and the identification information 8f can be read by the identification information reading unit 80 in a state where the specimen container 7 and the microtube 8 are held by the hand 22 of the first robot arm 20. Further, the operator arranges the placing table 70 on which the plurality of specimen containers 7 and the microtubes 8 are placed on the workbench 42 inside the safety cabinet 40.

In Step S4, the operator arranges the dispensing tip disposal unit 52 inside the safety cabinet 40.

In Step S5, the operator operates an operation screen of the command unit 91 to start the dispensing work by the dispensing system 100.

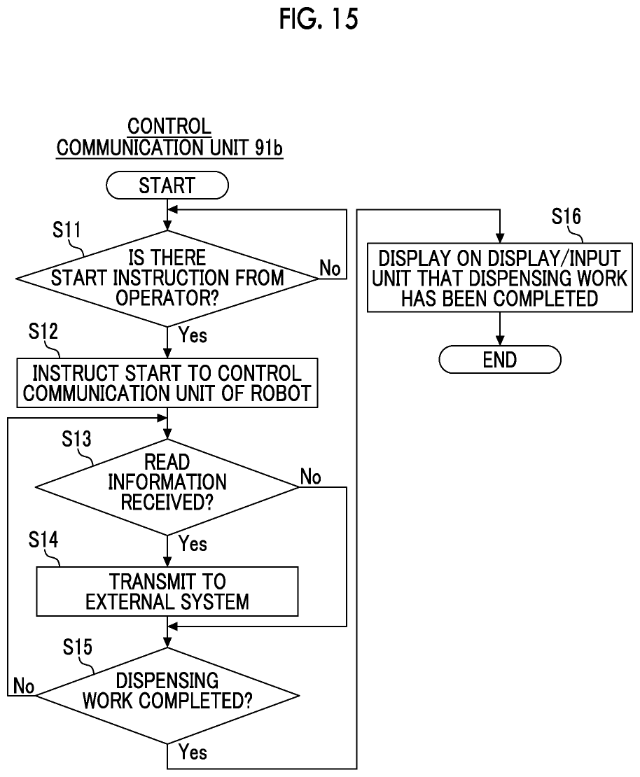

Next, the operation of the command unit 91 will be described with reference to FIG. 15. FIG. 15 is a flow chart illustrating an operation executed by the control communication unit 91b by the control communication unit 91b of the command unit 91 executing a program stored in advance.

In Step S11, the control communication unit 91b determines whether or not there is an instruction to start the dispensing work from the operator. When the operator operates the display/input unit 91a to input a work start instruction, the control communication unit 91b receives the dispensing work start instruction. The process of Step S11 is repeated until the operator gives an instruction to start the dispensing work. When it becomes yes in Step S11, the process proceeds to Step S12.

In Step S12, the control communication unit 91b transmits a signal for instructing the start of the dispensing work to the control communication unit 10a of the robot 10.

In Step S13, the control communication unit 91b determines whether or not the identification information 7d and the identification information 8f have been received from the identification information reading unit 80 via the control communication unit 10a of the robot 10. In Step S24e of FIG. 18, which will be described later, when the identification information reading unit 80 reads the identification information 7d of the specimen container 7 and the identification information 8f of the microtube 8 and the control communication unit 10a of the robot 10 transmits the read identification information to the control communication unit 91b of the command unit 91, it becomes yes in Step S13, and the process proceeds to Step S14. When it becomes no in Step S13, that is, when the identification information from the robot 10 does not come, the process proceeds to Step S15.

In Step S14, the control communication unit 91b transmits the received identification information 7d and identification information 8f to the external system 200. In response to this, the external system 200 associates the identification information 7d with the identification information 8f and stores the association therebetween in the storage unit. As a result, the identification information 7d assigned to the specimen container 7, the specimen number in the present embodiment, the identification information 8f assigned to the microtube 8, and the serial number of the microtube 8 in the present embodiment are associated with each other.

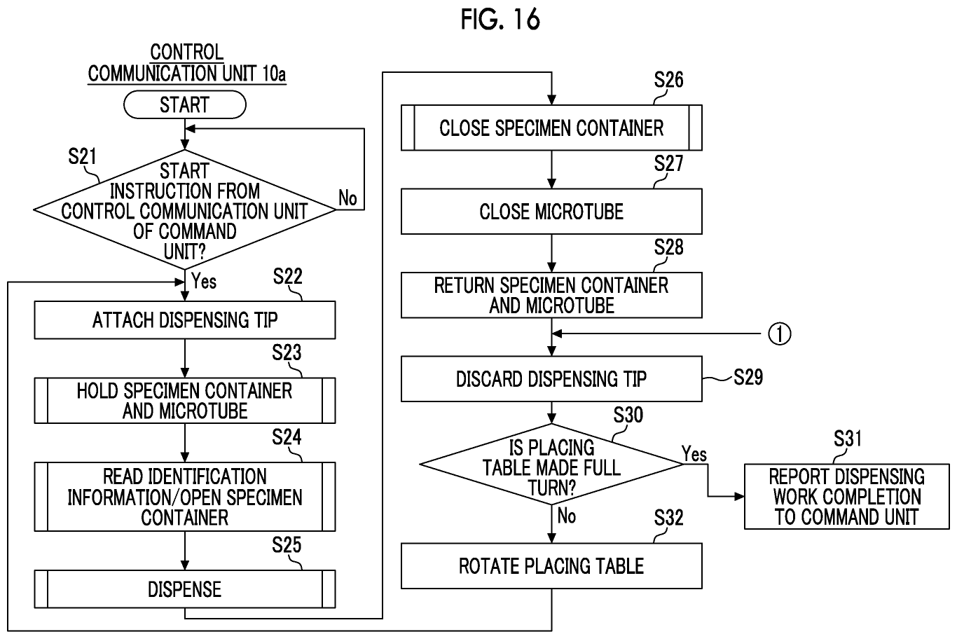

In Step S15, the control communication unit 91b determines whether or not the dispensing work has been completed for all the specimens placed on the placing table 70. When a work completion report is received from the control communication unit 10a of the robot 10 in Step S31 of FIG. 16 to be described later, it becomes yes in Step S15, and the control communication unit 91b advances the process to Step S16. In Step S16, the control communication unit 91b displays on the display/input unit 91a that the dispensing work has been completed. When it becomes no in Step S15, that is, when the work completion report has not been received, the control communication unit 91b returns the process to Step S13. That is, it is determined whether or not the identification information 7d of the specimen container 7 and the identification information 8f of the microtube 8 to be dispensed next are received.

Next, with reference to FIG. 16, the operation of the dispensing system 100 after the operator commands the start of the dispensing system 100 will be described. FIG. 16 is a flow chart illustrating the operation executed by the control communication unit 10a by the control communication unit 10a of the robot 10 by executing a program stored in advance.

In this embodiment, in a state where the body 11 that supports at least the first robot arm 20 and the second robot arm 30 is arranged outside the safety cabinet 40, and the hand 22 provided on the first robot arm 20 and the dispenser 33 provided in the second robot arm 30 are inserted into the safety cabinet 40, the dispensing work is performed. Specifically, the first robot arm 20, the second robot arm 30, and the body 11 are arranged outside the safety cabinet 40. The hand 22, the first chuck 23, and the second chuck 24 of the first robot arm 20 are arranged inside the safety cabinet 40. The hand 32 and the dispenser 33 of the second robot arm 30 are arranged inside the safety cabinet 40. Hereinafter, a specific description will be given.

In Step S21, the control communication unit 10a determines whether or not a signal for instructing the start of the dispensing work has been received from the control communication unit 91b of the command unit 91. The process of Step S21 is repeated until a signal for instructing the start of the dispensing work is transmitted from the control communication unit 91b of the command unit 91. When it becomes yes in Step S21, the control communication unit 10a advances the process to Step S22.

In Step S22, the control communication unit 10a drives the second robot arm 30 to perform the operation of attaching the dispensing tip 33b to the pipette 33a of the dispenser 33. More specifically, as described above, the second robot arm 30 lowers the pipette 33a of the dispenser 33 toward the dispensing tip 33b placed on the dispensing tip rack 51 and inserts the lower end portion of the pipette 33a into the opening of the dispensing tip 33b, and thus, the dispensing tip 33b is attached to the pipette 33a.

In Step S23, the control communication unit 10a drives the first robot arm 20 to cause the hand 22 to perform the operation of holding both the specimen container 7 and the microtube 8. That is, the control communication unit 10a drives the first robot arm 20 to cause the first chuck 23 and the second chuck 24 of the hand 22 to hold the specimen container 7 and the microtube 8 placed on the placing table 70 one by one. The details of the holding operation of the specimen container 7 and the microtube 8 will be described later.

Next, in Step S24, the control communication unit 10a drives the first robot arm 20 to perform the operation of moving the specimen container 7 and the microtube 8 held by the hand 22 to the vicinity of the identification information reading unit 80. Then, the screw cap 7b of the specimen container 7 is held by the holding rotator 61 of the lid opener/closer 60. In this state, the identification information 7d of the identification information label 7c attached to the specimen container 7 and the identification information 8f of the identification information label 8e attached to the microtube 8 are read by the identification information reading unit 80a and the identification information reading unit 80b, respectively.

Further, in Step S24, before the step of dispensing the specimen into the microtube 8, the control communication unit 10a transmits the control signal to the lid opener/closer 60 and drives the first robot arm 20. Accordingly, inside the safety cabinet 40, in a state where the main body 7a of the specimen container 7 is held by the hand 22 of the first robot arm 20, the lid opener/closer 60 performs the operation of opening the screw cap 7b of the specimen container 7 in cooperation with the hand 22 of the first robot arm 20. Specifically, the specimen container 7 is moved by the hand 22 of the first robot arm 20 while the screw cap 7b is rotated by the holding rotator 61 to open the screw cap 7b. The details of the operation of reading the identification information 7d and the identification information 8f and opening the screw cap 7b of the specimen container 7 will be described later.

Next, in Step S25, the control communication unit 10a drives the second robot arm 30 in a state of holding both the specimen container 7 and the microtube 8 by the hand 22 of the first robot arm 20 to cause the dispenser 33 of the second robot arm 30 to perform the operation of dispensing the specimen accommodated in the specimen container 7 into the microtube 8. Specifically, the hand 22 provided in the first robot arm 20 and the dispenser 33 provided in the second robot arm 30 are controlled by the control communication unit 10a to dispense the specimen accommodated in the specimen container 7 into the microtube 8 in the state of being inserted into the safety cabinet 40.

The dispenser 33 sucks the specimen accommodated in the specimen container 7 and dispenses the sucked specimen into the microtube 8. Whether or not the specimen is correctly sucked is confirmed by a pressure type suction confirmation unit. Further, at the time of sucking the specimen, the pipette 33a is not inserted into the inside of the specimen container 7, but the dispensing tip 33b is inserted. Further, when the sucked specimen is dispensed into the microtube 8, the tip of the dispensing tip 33b is arranged to be located below a liquid surface of the specimen which is the previously discharged liquid to prevent a discharged liquid from splashing. The details of the dispensing work will be described later.

Next, in Step S26, after the step of dispensing the specimen into the microtube 8, the control communication unit 10a transmits the control signal to the lid opener/closer 60 and drives the first robot arm 20, and the operation of closing the screw cap 7b of the specimen container 7 in the state where the screw cap 7b is opened in cooperation with the hand 22 of the first robot arm 20 is performed inside the safety cabinet 40. Specifically, the main body 7a of the specimen container 7 is held by the holding rotator 61 and moved to the vicinity of the screw cap 7b, and the screw cap 7b is rotated. Further, the main body 7a of the specimen container 7 is moved upward with the rotation. As a result, the screw cap 7b is attached to the main body 7a. The detailed operation of closing the screw cap 7b will be described later.

Next, in Step S27, after the step of dispensing the specimen into the microtube 8, the control communication unit 10a drives the first robot arm 20 to perform the operation of closing the lid unit 8b of the microtube 8 after the specimen accommodated in the specimen container 7 is dispensed by the block 90. Specifically, as described above, the microtube 8 is moved by the first robot arm 20 and the lid unit 8b abuts on the block 90. As a result, the lid unit 8b is closed.

Next, in Step S28, the control communication unit 10a drives the first robot arm 20 to perform the operation of returning the specimen container 7 and the microtube 8 to the original position of the placing table 70 having a disk shape.

Next, in Step S29, the control communication unit 10a drives the second robot arm 30 to move the dispenser 33 above the dispensing tip disposal unit 52 and abuts the upper portion of the tip ejector 33c provided in the second robot arm on the block 33d, and thus, the dispensing tip 33b attached to the tip of the pipette 33a is removed.

Next, in Step S30, the control communication unit 10a determines whether or not the placing table 70 has made a full turn, that is, whether or not the dispensing work for all the specimen containers 7 and microtubes 8 placed on the placing table 70 has been completed. When the placing table 70 makes a full turn, it becomes yes in Step S30, the control communication unit 10a advances the processing to Step S31, and transmits a signal to the command unit 91 reporting that the dispensing work is completed.

When it becomes no in Step S30, the control communication unit 10a transmits a control signal to the placing table 70 in Step S32, so that the rotatable placing table 70 having a disk shape on which the plurality of specimen containers 7 and the plurality of microtubes 8 are placed in a circumferential shape are rotated by a predetermined angle. As a result, the specimen container 7 and the microtube 8 to be dispensed next are moved to a position where the hand 22 of the first robot arm 20 can be held. After that, the control communication unit 10a returns the process to Step S22. The operations of Steps S22 to S32 are repeated until all the dispensing works of the plurality of specimen containers 7 and the plurality of microtubes 8 placed on the placing table 70 are completed.

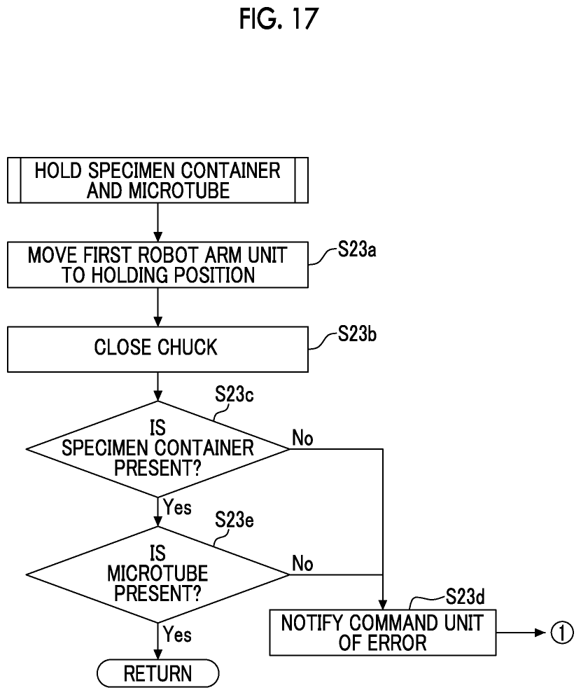

Next, with reference to FIG. 17, the details of the holding operation of the specimen container 7 and the microtube 8 will be described.

In Step S23a, the control communication unit 10a moves the hand 22 of the first robot arm 20 to a position where the specimen container 7 and the microtube 8 can be held.

In Step S23b, the control communication unit 10a causes the hand 22 to perform the operation of closing the first chuck 23 and the second chuck 24. Specifically, the motor 23c of the first chuck 23 receives a control signal from the control communication unit 10a and is driven, so that the pair of support pieces 23a and 23b are closed. Further, the motor 24c of the second chuck 24 receives a control signal from the control communication unit 10a and is driven, so that the pair of support pieces 24a and 24b are closed.

In Step S23c, the control communication unit 10a determines whether or not the specimen container 7 is present. That is, as described above, when the pair of support pieces 23a and 23b are brought closer to a predetermined distance by driving the motor 23c, the control communication unit 10a determines that the specimen container 7 does not exist at the corresponding position of the placing table 70. When it becomes no in Step S23c, the process proceeds to Step S23d, and the control communication unit 10a notifies the command unit 91 of the error. After that, the control communication unit 10a advances the process to Step S29 of FIG. 16.

When it becomes yes in Step S23c, the process proceeds to Step S23e, and the control communication unit 10a determines whether or not the microtube 8 is present. That is, as described above, when the pair of support pieces 24a and 24b are brought closer to a predetermined distance by driving the motor 24c, the control communication unit 10a determines that the microtube 8 does not exist at the corresponding position of the placing table 70. When it becomes no in Step S23e, the process proceeds to Step S23d, and the control communication unit 10a notifies the command unit 91 of the error. After that, the control communication unit 10a advances the process to Step S29 of FIG. 16. When it becomes yes in Step S23e, the control communication unit 10a returns the process to the main routine of FIG. 16.

Next, with reference to FIG. 18, the details of the operations of reading the identification information 7d and the identification information 8f and opening the screw cap 7b of the specimen container 7 will be described.

In Step S24a, the control communication unit 10a causes the first robot arm 20 to move the specimen container 7 held by the hand 22 to the vicinity of the lid opener/closer 60.

Next, in Step S24b, the control communication unit 10a causes the lid opener/closer 60 to close the claw portion 62. After that, the control communication unit 10a causes the first chuck 23 of the hand 22 to release the holding state of the specimen container 7.

Next, in Step S24c, the control communication unit 10a moves the first robot arm 20 to move the microtube 8 to the reading position of the identification information 8f, that is, the front position of the identification information reading unit 80b.

Next, in Step S24d, the control communication unit 10a transmits a control signal to the lid opener/closer 60, and causes the holding rotator 61 to rotate the specimen container 7. The control communication unit 10a transmits a control signal to the identification information reading unit 80 so that the identification information 7d of the specimen container 7 is read by the identification information reading unit 80a, and the identification information 8f of the microtube 8 is read by the identification information reading unit 80b.

Next, in Step S24e, the control communication unit 10a transmits the identification information 7d of the specimen container 7 and the identification information 8f of the microtube 8 to the command unit 91.

Next, in Step S24f, the control communication unit 10a drives the first robot arm 20 to cause the first chuck 23 of the hand 22 to hold the specimen container 7 again.

Next, in Step S24g, the control communication unit 10a drives the first robot arm 20 while transmitting a control signal to the lid opener/closer 60 and rotating the screw cap 9b of the specimen container 7 by the holding rotator 61, and lowers the hand 22 holding the main body 7a of the specimen container 7 to open the screw cap 9b. After that, the control communication unit 10a advances the process to Step S25 of FIG. 16.

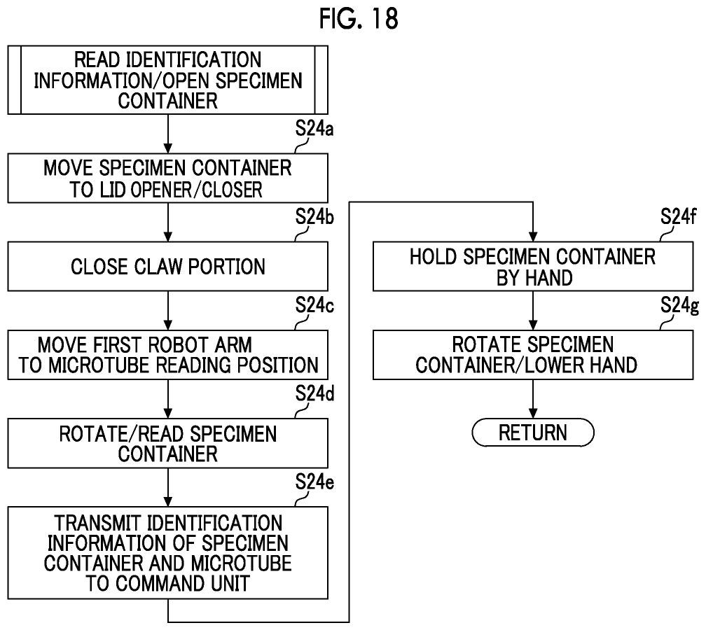

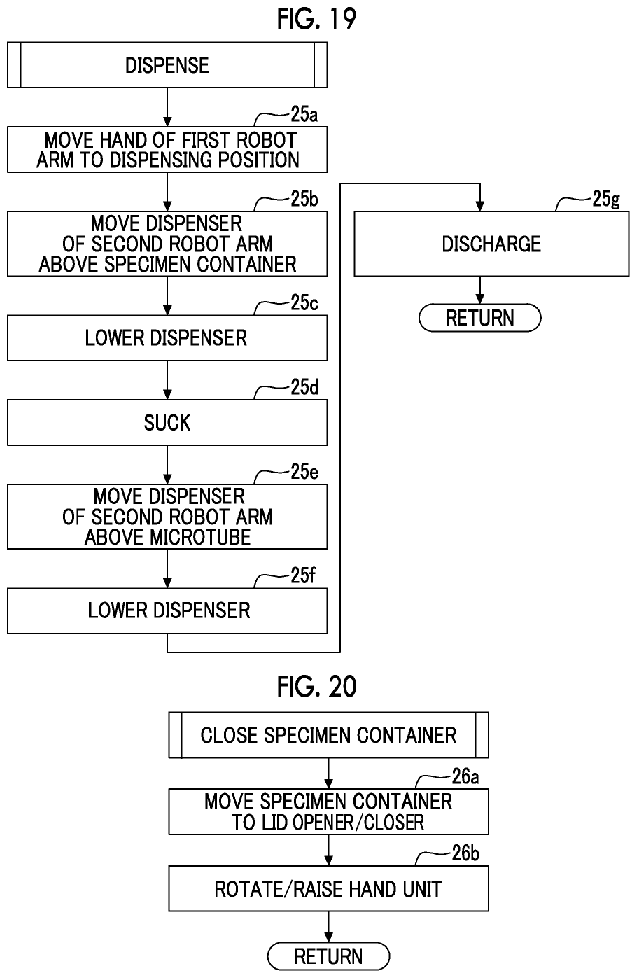

Next, the details of the dispensing work will be described with reference to FIG. 19.

In Step S25a, the control communication unit 10a moves the hand 22 of the first robot arm 20 to the dispensing position.

Next, in Step S25b, the control communication unit 10a drives the second robot arm 30 to move the dispenser 33 above the specimen container 7 held by the hand 22 of the first robot arm 20.

Next, in Step S25c, the control communication unit 10a drives the second robot arm 30 to lower the dispenser 33. As a result, the dispensing tip 33b is inserted into the specimen in the specimen container 7.

Next, in Step S25d, the control communication unit 10a drives the pipette 33a of the dispenser 33 to supply negative pressure to the dispensing tip 33b, and thus, the specimen is sucked into the dispensing tip 33b.

Next, in Step S25e, the control communication unit 10a moves the dispenser 33 above the microtube 8 by the second robot arm 30.

Next, in Step S25f, the control communication unit 10a drives the second robot arm 30 to lower the dispenser 33. As a result, the dispensing tip 33b that sucks the specimen is inserted into the microtube 8.

Next, in Step S25g, the control communication unit 10a drives the pipette 33a of the dispenser 33 to supply positive pressure to the dispensing tip 33b, so that the specimen sucked into the dispensing tip 33b is discharged to the microtube 8. After that, the control communication unit 10a advances the process to Step S26 of FIG. 16.

Next, with reference to FIG. 20, the details of the operation of closing the specimen container 7 will be described.

In Step S26a, the control communication unit 10a drives the first robot arm 20 to move the main body 7a of the specimen container 7 held by the hand 22 to the vicinity of the lid opener/closer 60. In this case, the screw cap 7b removed in Step S24g of FIG. 18 is held by the claw portion 62 of the lid opener/closer 60.

In Step S26b, the control communication unit 10a transmits a control signal to the lid opener/closer 60, and thus, while the screw cap 7b held to the claw portion 62 by the holding rotator 61 is rotated in the direction opposite to the rotation direction in Step S24g, the main body 7a of the specimen container 7 held to the hand 22 by the first robot arm 20 is raised. As a result, the screw cap 7b is closed. After that, the control communication unit 10a returns the process to Step S28 in FIG. 16.

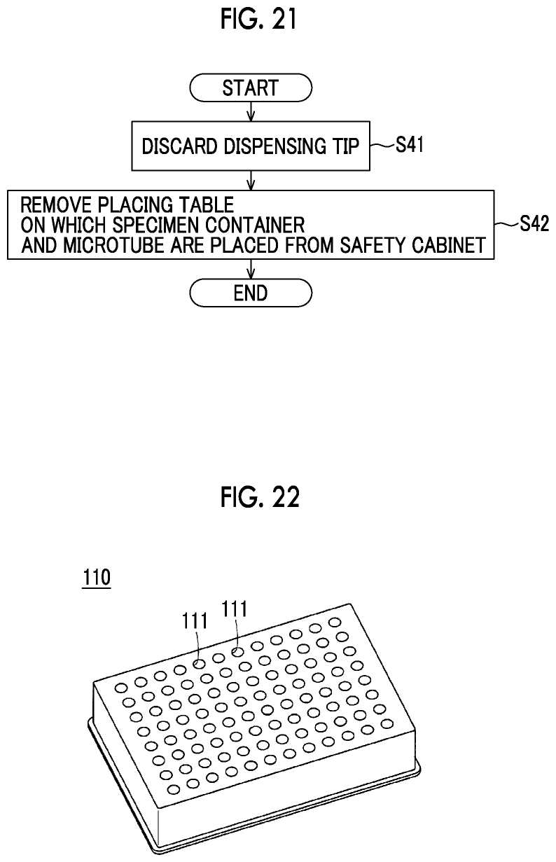

Next, with reference to FIG. 21, the work of the operator after the dispensing work is completed will be described.

In Step S41, the operator discards the used dispensing tip 33b arranged inside the safety cabinet 40.

In Step S42, the operator removes the placing table 70 having a disk shape on which the specimen container 7 and the microtube 8 for which the dispensing work has been completed are placed to the outside of the safety cabinet 40. Then, the operator moves the removed placing table 70 to the workbench 3 where a work of extracting the nucleic acid is performed. After that, the work of extracting nucleic acid from the specimen accommodated in the microtube 8, preparation of a PCR reaction solution using the extracted nucleic acid, addition of positive control to a PCR reaction plate, and amplification and detection in the PCR test are performed. That is, PCR amplification and detection are performed.

(Effect of Present Embodiment)

In the present embodiment, the following effects can be obtained.

(Effect of Analysis System)

In the present embodiment, as described above, in the state where at least the body 11 of the robot 10 is arranged outside the safety cabinet 40 and the hand 22 provided in the first robot arm 20 and the dispenser 33 provided in the second robot arm 30 are inserted into the safety cabinet 40, the dispenser 33 dispenses the specimen accommodated in the specimen container 7 held by the hand 22 into the microtube 8. As a result, by simply arranging the robot 10 adjacent to the safety cabinet 40 so that the hand 22 of the first robot arm 20 and the dispenser 33 of the second robot arm 30 are inserted into the safety cabinet 40, it is possible to perform the dispensing work by the robot 10. For this reason, it is easy to replace the dispensing work, which is conventionally performed by the inspection engineer by inserting his/her hand into the safety cabinet 40, with the robot 10. Since the existing safety cabinet 40 can be utilized, the introduction cost for the user can be suppressed. In addition, there is no need to significantly change the workflow associated with the dispensing work that is conventionally performed by the inspection engineer. Further, when the robot 10 is installed inside the safety cabinet 40, the dispensing work cannot be performed until the work is completed during the maintenance of the robot 10. Meanwhile, in the present embodiment, by separating the hand 22 of the first robot arm 20 and the dispenser 33 of the second robot arm 30 of the robot 10 from the safety cabinet 40 during the maintenance, that is, by separating the robot 10 from the safety cabinet 40, manual dispensing work can be performed instead of the robot 10. That is, it is possible to prevent the dispensing work from being delayed. In addition, even when it becomes necessary to process a specimen that cannot be handled in normal operation, such as a specimen container having a shape that does not fit the placing table 70, by separating the robot 10 from the safety cabinet 40, the manual dispensing work can be performed. In this way, by automating the specimen dispensing work that is conventionally performed manually in the safety cabinet 40 by the robot 10, it is possible to perform introduction at low cost and easily perform switching from the robot 10 to the inspection engineer while reducing risks of human error and a worker infection.

Further, in the present embodiment, as described above, the specimen container 7 includes the main body 7a and the screw cap 7b that covers the opening of the main body 7a, and the operation of opening the screw cap 7b of the specimen container 7 is performed inside the safety cabinet 40. As a result, the operation of opening the screw cap 7b of the specimen container 7 is also automated by the robot 10, so that it is possible to save the labor of manually opening the screw cap 7b of the specimen container 7 and prevent biohazard. In addition, the biohazard means infection from the specimen.

Further, in the present embodiment, as described above, the operation of closing the opened screw cap 7b of the specimen container 7 is performed inside the safety cabinet 40. As a result, the operation of closing the screw cap 7b of the specimen container 7 is also automated by the robot 10, so that it is possible to save the labor of manually opening the screw cap 7b of the specimen container 7 and prevent biohazard.

Further, in the present embodiment, as described above, the lid opener/closer 60 is further provided, which is arranged inside the safety cabinet 40 and opens or closes the screw cap 7b of the specimen container 7 holding the main body 7a by the hand 22 of the first robot arm 20 in cooperation with the hand 22 of the first robot arm 20. As a result, the operation of closing the screw cap 7b of the specimen container 7 can be automated by the hand 22 of the first robot arm 20 and the lid opener/closer 60 without the need for manual labor.

Further, in the present embodiment, as described above, the screw cap 7b is attached to or removed from the main body 7a by rotating with respect to the main body 7a, and the lid opener/closer 60 includes the holding rotator 61 that holds and rotates the screw cap 7b. As a result, the screw cap 7b can be easily attached to or removed from the main body 7a by rotating the screw cap 7b by the holding rotator 61.

Further, in the present embodiment, as described above, the holding rotator 61 moves so that the hand 22 of the first robot arm 20 is separated from the holding rotator 61 while holding and rotating the screw cap 7b, and thus, the screw cap 7b is removed from the main body 7a. Here, in order to open the screw cap 7b, as the screw cap 7b is rotated with respect to the main body 7a, the screw cap 7b tries to move to be separated from the main body 7a. Therefore, by configuring as described above, the distance between the screw cap 7b and the main body 7a gradually increases while the screw cap 7b is rotated at the same position, so that the screw cap 7b can be easily and smoothly removed from the main body 7a.

Further, in the present embodiment, as described above, the rotatable placing table 70 having a disk shape is further provided, which is arranged inside the safety cabinet 40 and in which at least the plurality of specimen containers 7 are placed in a circumferential shape. For example, when the plurality of specimen containers 7 are arranged in a matrix, depending on the positions of the plurality of specimen containers 7 arranged in the matrix, the distance between the specimen container 7 and the hand 22 for holding the specimen container 7 may be relatively large. In this case, a moving distance of the hand 22 becomes large. Therefore, by configuring as described above, by rotating the placing table 70 having a disk shape, the specimen container 7 to be held can be moved in the vicinity of the hand 22, and thus, it is possible to prevent the moving distance of the hand 22 from increasing.

Further, in the present embodiment, as described above, the plurality of microtubes 8 are provided, and both the plurality of specimen containers 7 and the plurality of microtubes 8 are placed in a circumferential shape on the placing table 70 having a disk shape. As a result, unlike the case where the plurality of specimen containers 7 and the plurality of microtubes 8 are arranged in a matrix, since the specimen container 7 and the microtube 8 to be held can be moved to the vicinity of the hand 22 by rotating the placing table 70 having a disk shape, it is possible to prevent the moving distance of the hand 22 from increasing.

Further, in the present embodiment, as described above, the identification information reading unit 80a for reading the identification information 7d of the identification information label 7c attached to the specimen container 7 is further provided, the hand 22 of the first robot arm 20 moves the specimen container 7 held by the hand 22 to the position where the identification information reading unit 80a can read the identification information 7d, and thus, the identification information reading unit 80a reads the identification information 7d of the identification information label 7c attached to the specimen container 7. As a result, the reading of the identification information 7d of the identification information label 7c attached to the specimen container 7 is automated, so that it is possible to save the labor of manually reading the identification information 7d of the identification information label 7c attached to the specimen container 7.

Further, in the present embodiment, as described above, the identification information reading unit 80b for reading the identification information 8f of the identification information label 8e attached to the microtube 8 is further provided. The hand 22 of the first robot arm 20 is configured to hold the specimen container 7 and the microtube 8. The hand 22 of the first robot arm 20 moves the specimen container 7 and the microtube 8 held by the hand 22 to the positions at which the identification information reading unit 80a and the identification information reading unit 80b can read the identification information 7d and identification information 8f, the identification information reading unit 80a and the identification information reading unit 80b read have the identification information 7d of the identification information label 7c attached to the specimen container 7 and the identification information 8f of the identification information label 8e attached to the microtube 8, respectively. As a result, the reading of the identification information 7d of the identification information label 7c attached to the specimen container 7 and the identification information 8f of the identification information label 8e attached to the microtube 8 is automated, so that it is possible to save the labor of manually reading the identification information 7d attached to the specimen container 7 and the identification information 8f of the identification information label 8e attached to the microtube 8.

Further, in the present embodiment, as described above, the hand 22 of the first robot arm 20 includes the first chuck 23 that holds the specimen container 7 and the second chuck 24 that holds the microtube 8, and inside the safety cabinet 40, the dispenser 33 dispenses the specimen accommodated in the specimen container 7 held by the first chuck 23 of the hand 22 into the microtube 8 held by the second chuck 24. As a result, since both the specimen container 7 and the microtube 8 are held by the hand 22 of the first robot arm 20, the distance between the specimen container 7 and the microtube 8 becomes relatively small. As a result, the moving distance of the dispenser 33 for dispensing the specimen sucked from the specimen container 7 into the microtube 8 can be reduced.

Further, in the present embodiment, as described above, the microtube 8 includes the main body 8a and the lid unit 8b connected to the main body 8a via the connector 8c, and the operation of closing the lid unit 8b of the microtube 8 after the specimen accommodated in the specimen container 7 is dispensed is performed inside the safety cabinet 40. As a result, the operation of closing the lid unit 8b of the microtube 8 is automated, so that it is possible to save the labor of manually closing the lid unit 8b of the microtube 8 and prevent the biohazard.

Further, in the present embodiment, as described above, the block 90 is further provided, which is arranged inside the safety cabinet 40 and closes the lid unit 8b of the microtube 8 after the specimen accommodated in the specimen container 7 is dispensed in cooperation with the hand 22 of the first robot arm 20. As a result, the operation of closing the lid unit 8b of the microtube 8 is automated by the hand 22 of the first robot arm 20, so that it is possible to save the labor of manually closing the lid unit 8b of the microtube 8 and prevent the biohazard.

Further, in the present embodiment, as described above, the block 90 includes the upper surface 90a, the side surface 90b, the inclined surface 90c, and the lower surface 90d on which the lid unit 8b of the microtube 8 abuts, and the microtube 8 is relatively moved with respect to the upper surface 90a, the side surface 90b, the inclined surface 90c, and the lower surface 90d by the first robot arm 20, the lid unit 8b connected to the main body 8a via the connector 8c abuts on the upper surface 90a, the side surface 90b, the inclined surface 90c, and the lower surface 90d of the block 90, and thus, the lid unit 8b is closed. As a result, the lid unit 8b can be easily closed only by abutting the lid unit 8b on the upper surface 90a, the side surface 90b, the inclined surface 90c, and the lower surface 90d. Further, unlike the case where the lid closer for closing the lid unit 8b is configured by a robot hand or the like, the configuration of the lid closer can be simplified.

Further, in the present embodiment, as described above, the workbench 42 which is arranged in the safety cabinet 40 and on which the specimen container 7 is placed, and the base 12 on which the robot 10 is placed are further provided, and the workbench 42 and the base 12 are integrally configured. As a result, since the relative position of the robot 10 with respect to the workbench 42 is fixed, it is possible to prevent inaccurate dispensing work from being performed due to positional deviation of the robot 10 with respect to the workbench 42.

Further, in the present embodiment, as described above, the robot 10 includes the dual-arm horizontal articulated robot including the first robot arm 20, the second robot arm 30, and the body 11. As a result, the horizontal articulated robot has a relatively simple configuration as compared with a vertical articulated robot and the like, and thus, the dispensing system 100 can be configured with a simple configuration.

Further, in the present embodiment, as described above, the command unit 91 is further provided, which is arranged outside the safety cabinet 40 and receives the operation for commanding the start of the dispensing work by the robot 10. As a result, the robot 10 can easily start the dispensing work only by the worker operating the command unit 91.

Further, in the present embodiment, as described above, the robot 10 and the safety cabinet 40 are arranged in the negative pressure room 2, and the specimen container 7 is supplied from the outside of the room 2 into the room 2. As a result, the leakage of the specimen or the like to the outside of the room 2 can be suppressed by the negative pressure inside the room 2.

Further, in the present embodiment, as described above, the specimen includes the specimen used for the PCR test, and the robot 10 dispenses the specimen accommodated in the specimen container 7 into the microtube 8 as a pretreatment for the PCR test. As a result, the pretreatment of the PCR test is automated in the dispensing system 100, and thus, the time for the pretreatment of the PCR test can be shortened.

(Effect of Dispensing Method)

In the present embodiment, as described above, the step of dispensing the specimen into the microtube 8 by using the hand 22 of the first robot arm 20 and the hand 32 of the second robot arm 30 is provided. As a result, the dispensing work by the robot 10 can be performed only by arranging the robot 10 adjacent to the safety cabinet 40. For this reason, it is easy to replace the dispensing work, which is conventionally performed by the inspection engineer by inserting his/her hand into the safety cabinet 40, with the robot 10. Since the existing safety cabinet 40 can be utilized, the introduction cost for the user can be suppressed. In addition, there is no need to significantly change the workflow associated with the dispensing work that is conventionally performed by the inspection engineer. Further, when the robot 10 is installed inside the safety cabinet 40, the dispensing work cannot be performed until the work is completed during the maintenance of the robot 10. Meanwhile, in the present embodiment, by separating the hand 22 of the first robot arm 20 and the dispenser 33 of the second robot arm 30 of the robot 10 from the safety cabinet 40 during the maintenance, that is, by separating the robot 10 from the safety cabinet 40, manual dispensing work can be performed instead of the robot 10. That is, it is possible to prevent the dispensing work from being delayed. In addition, even when it becomes necessary to process a specimen that cannot be handled in normal operation, such as a specimen container having a shape that does not fit the placing table 70, by separating the robot 10 from the safety cabinet 40, the manual dispensing work can be performed. In this way, by automating the specimen dispensing work that is conventionally performed manually in the safety cabinet 40 by the robot 10, it is possible to provide the dispensing method capable of performing introduction at low cost and easily performing switching from the robot 10 to the inspection engineer while reducing risks of human error and a worker infection.

Further, in the present embodiment, as described above, the dispensing method further includes the step of opening the screw cap 7b of the specimen container 7 inside the safety cabinet 40 after the step of holding the specimen container 7 by the hand 22 and before the step of dispensing the specimen into the microtube 8. As a result, the operation of opening the screw cap 7b of the specimen container 7 is also automated by the robot 10, and thus, the manual step can be omitted and the biohazard can be prevented in the dispensing method.

Further, in the present embodiment, as described above, the dispensing method further includes the step of closing the opened screw cap 7b of the specimen container 7 inside the safety cabinet 40 after the step of dispensing the specimen into the microtube 8. As a result, the operation of closing the screw cap 7b of the specimen container 7 is also automated by the robot 10, and thus, the manual step can be omitted and the biohazard can be prevented in the dispensing method.

Further, in the present embodiment, as described above, the dispensing method further includes the step of closing the lid unit 8b of the microtube 8 after the specimen accommodated in the specimen container 7 is dispensed after the step of dispensing the specimen into the microtube 8. As a result, the operation of closing the lid unit 8b of the microtube 8 is automated, and thus, the manual step can be omitted and the biohazard can be prevented in the dispensing method.

Further, in the present embodiment, as described above, the dispensing method further includes the step of rotating, using the first robot arm 20, the rotatable placing table 70 having a disk shape on which the plurality of the specimen containers 7 are placed in a circumferential shape by a predetermined angle, before the step of holding the specimen container 7 by the hand 22. As a result, the operation of rotating the placing table 70 having a disk shape is automated, and thus, the manual process can be omitted and the biohazard can be prevented in the dispensing method.

Further, in the present embodiment, as described above, the dispensing method further includes the step of holding both the specimen container 7 and the microtube 8 by the hand 22 of the first robot arm 20. As a result, it is possible to suppress an increase in the number of robot arm units, unlike the case where the specimen container 7 and the microtube 8 are separately held by using the plurality of robot arm units.

Further, in the present embodiment, as described above, the dispensing method further includes the step of dispensing the specimen accommodated in the specimen container 7 into the microtube 8 in a state where both the specimen container 7 and the microtube 8 are held by the hand 22 of the first robot arm 20. As a result, it is possible to suppress an increase in the number of robot arm units, unlike the case where the dispensing work is performed in a state where the specimen container 7 and the microtube 8 are separately held by using the plurality of robot arm unit.

### Modification Example

It should be noted that the embodiment described here is exemplary in all respects and is not considered to be restrictive. A scope of the present disclosure is illustrated by claims rather than the descriptions of the above-described embodiment, and further includes all modifications (modification examples) within the meaning and scope equivalent to the claims.

For example, in the above embodiment, the microtube 8 is provided as the dispensing container of the present disclosure, but the present disclosure is not limited to this. For example, as illustrated in FIG. 22, as the dispensing container of the present disclosure, a plate 110 provided with a plurality of hole portions 111 may be used. The plurality of hole portions 111 are relatively deep wells. In this case, the first robot arm 20 holds only the specimen container 7. Further, only the specimen container 7 is placed on the placing table 70 having a disk shape. Further, the plate 110 is arranged inside the safety cabinet 40. Then, the specimen sucked from the specimen container 7 is discharged into the hole portion 111 of the plate 110. The plate 110 is an example of the dispensing container.

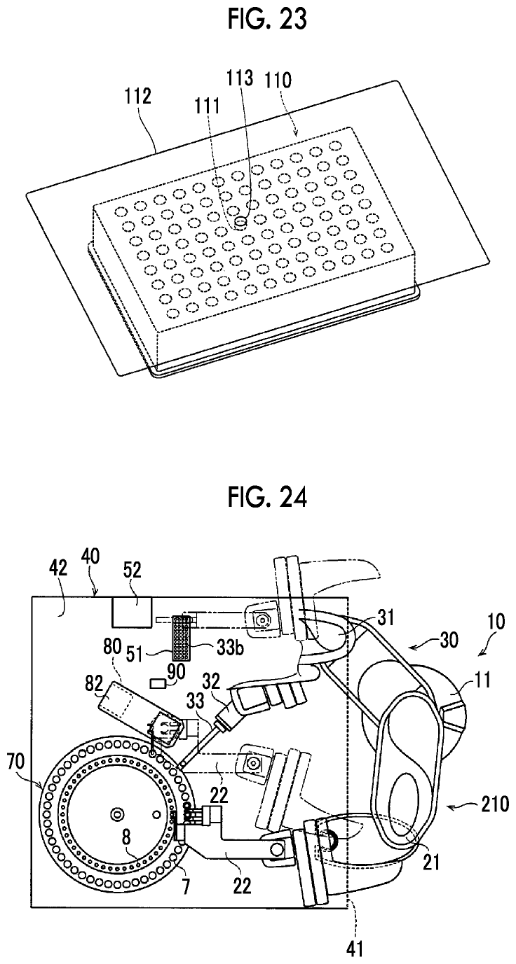

Further, as illustrated in FIG. 23, when the plate 110 is used, the specimen is discharged in a state where the cover member 112 having a plate shape is placed on a surface of the plate 110 so that the specimen is not mixed into the other hole portions 111 when the specimen is discharged into one hole portion 111. The cover member 112 is provided with one hole portion 113, and the specimen is discharged in a state where the hole portion 111 of the plate 110 to be discharged and the hole portion 113 of the cover member 112 overlap each other. Accordingly, it is possible to prevent the specimen from being mixed into the hole portion 111 of the plate 110 other than a target to be discharged.

Further, in the above embodiment, the example is illustrated in which the first robot arm 20, the second robot arm 30, and the body 11 are arranged outside the safety cabinet 40, but the present disclosure is not limited to this. For example, as illustrated in FIG. 24, in a state where the body 11 of a robot 210 is arranged outside the safety cabinet 40 and at least one of the first robot arm 20 provided with the hand 22 and the second robot arm 30 provided with the dispenser 33 is inserted into the safety cabinet 40, the specimen accommodated in the specimen container 7 may be dispensed into the microtube 8. In FIG. 24, both the first robot arm 20 provided with the hand 22 and the second robot arm 30 provided with the dispenser 33 are inserted into the safety cabinet 40. As a result, a distance between at least one of the first robot arm 20 and the second robot arm 30 and the position inside the safety cabinet 40 where the dispensing work is performed becomes relatively small. That is, at least one of a length of the hand 22 of the first robot arm 20 and a length of the hand 32 provided with the dispenser 33 of the second robot arm 30 can be reduced. As a result, at least one of the hand 22 of the first robot arm 20 and the hand 32 of the second robot arm 30 can be moved with a relatively small force. The relatively small force means a relatively small torque.

For example, in order to attach the dispensing tip 33b to the pipette 33a of the dispenser 33, the pipette 33a of the dispenser 33 may be pressed against the dispensing tip 33b for a predetermined time. In this case, by inserting at least the second robot arm 30 into the safety cabinet 40, it is possible to reduce the length of the hand 32 of the second robot arm 30. As a result, the pipette 33a of the dispenser 33 can be pressed against the dispensing tip 33b with a relatively small force.

Further, in the above embodiment, the example is illustrated in which the operation of opening or closing the screw cap 7b of the specimen container 7 and the operation of closing the screw cap 7b of the microtube 8 are automatically performed by the dispensing system 100, but the present disclosure is not limited to this. For example, any of the operations described above may be performed manually.

Further, in the above embodiment, the example of opening or closing the screw cap 7b by rotating the screw cap 7b by the lid opener/closer 60 has been illustrated, but the present disclosure is not limited to this. For example, the screw cap 7b may be opened or closed by rotating the screw cap 7b by the hand of the robot arm unit provided separately.

Further, in the above embodiment, the example is illustrated in which the lid unit of the specimen container 7 is constituted by the screw cap 7b, but the present disclosure is not limited to this. A cap type lid unit may be used in which the lid unit of the specimen container 7 is pushed into the main body to close the specimen container 7.

Further, in the above embodiment, the example in which the plurality of specimen containers 7 and the plurality of microtubes 8 are placed on the rotatable placing table 70 having disk shape is illustrated, but the present disclosure is not limited to this. For example, the plurality of specimen containers 7 and the plurality of microtubes 8 may be arranged in the rack in a state of being arranged in a matrix.

Further, in the above embodiment, the example in which the placing table 70 is rotated by the drive unit 70b is illustrated, but the present disclosure is not limited to this. For example, the hand 22 of the first robot arm 20 may rotate the placing table 70 having a disk shape by a predetermined angle based on the command from the command unit 91 input via the control communication unit 10a. Further, the hand 22 of the first robot arm 20 rotates the placing table 70 having a disk shape by a predetermined angle. For example, the first chuck 23 or the second chuck 24 of the hand 22 holds and rotates the placing table 70. Alternatively, the placing table 70 is provided with a hole portion, and a pin having a rod shape held by the first chuck 23 or the second chuck 24 of the hand 22 is inserted into the hole portion in the placing table 70. Then, the placing table 70 is rotated by moving the pin having a rod shape by the hand 22.

As a result, unlike the case where a drive unit such as a motor is separately provided on the placing table 70 having a disk shape, the placing table 70 having a disk shape can be rotated while suppressing an increase in the number of parts. Further, unlike the case where a drive unit such as a motor is separately provided on the placing table 70 having a disk shape, it is possible to suppress an increase in the weight of the placing table 70 having a disk shape. As a result, after the dispensing operation for the specimen container 7 arranged on the placing table 70 having a disk shape is completed, the placing table 70 having a disk shape can be easily replaced with the new placing table 70 on which the specimen container 7 or the like to be dispensed next is arranged.

Further, in the above embodiment, the example in which the plurality of specimen containers 7 and the plurality of microtubes 8 are arranged inside the safety cabinet 40 is illustrated, but the present disclosure is not limited to this. For example, the plurality of specimen containers 7 and the plurality of microtubes 8 may be arranged outside the safety cabinet 40.

Further, in the above embodiment, the example is illustrated, in which the specimen container 7 and the microtube 8 are moved to the vicinity of the identification information reading unit 80 by the hand 22 of the first robot arm 20, and the identification information 7d and the identification information 8f are read, but the present disclosure is not limited to this. The identification information 7d and the identification information 8f may be read manually.

Further, in the above embodiment, the example is illustrated in which the lid unit 8b of the microtube 8 abuts on the block 90 to close the lid unit 8b, but the present disclosure is not limited to this. For example, the lid unit 8b may be closed by a separately provided robot hand.

Further, in the above embodiment, the example is illustrated in which the workbench 42 of the safety cabinet 40 and the base 12 on which the robot 10 is placed are integrally configured, but the present disclosure is not limited to this. For example, the workbench of the safety cabinet and the base on which the robot is placed may be configured as separate bodies.

Further, in the above embodiment, the example in which the robot 10 is constituted by the horizontal articulated robot is illustrated, but the present disclosure is not limited to this. For example, the robot may be configured by a vertical articulated robot.

Further, in the above embodiment, the example in which the specimen is a specimen used for the PCR test is illustrated, but the present disclosure is not limited to this. For example, the dispensing system of the present disclosure may be used for dispensing works such as antigen test, antibody test, and immunological test other than PCR test. The type of specimen to which the dispensing system 100 of the present embodiment can be suitably applied is not particularly limited, but a clinical specimen collected from a subject is preferable. In particular, clinical specimens used for infectious virus test are preferable. Preferred examples of clinical specimens are respiratory specimens such as pharyngeal swab, nostril swab, nasal discharge, saliva, sputum, and mouthwash. Other examples of clinical specimens are whole blood, serum, plasma, cerebrospinal fluid (CSF), pleural effusion, ascites, pericardial fluid, joint fluid, urine, and stool.

Further, in the above embodiment, the dispensing system 100 is arranged in the negative pressure room 2, but the present disclosure is not limited to this. For example, depending on the type of specimen, the dispensing system 100 may be arranged in a room having a pressure other than negative pressure.

Further, in the above embodiment, the example is illustrated in which one body 11 supports both the first robot arm 20 and the second robot arm 30, but the present disclosure is not limited to this. For example, two bodys that individually support the first robot arm 20 and the second robot arm 30 may be provided.

Further, in the above embodiment, the example is illustrated in which the specimen is dispensed into the microtube 8 by using the hand 22 of the first robot arm 20 and the hand 32 of the second robot arm 30, but the present disclosure is not limited to this. For example, the specimen container 7 and the microtube 8 are held and placed at a predetermined position by the hand of one robot arm. Then, the specimen in the specimen container 7 placed at a predetermined position may be dispensed into the microtube 8 by holding the dispenser by the hand of one robot arm.

Further, in the above embodiment, the example is illustrated in which the screw cap 7b in the specimen container 7 is opened or closed by the cooperative operation of the hand 22 of the first robot arm 20 and the lid opener/closer 60, but the present disclosure is not limited to this. For example, the hand 22 of the first robot arm 20 may be used to open or close the screw cap 7b of the specimen container 7 inside the safety cabinet 40. That is, the screw cap 7b may be directly held by the hand 22 of the first robot arm 20 and the screw cap 7b may be rotated to open or close the screw cap 7b. As a result, it is possible to save the labor of manually opening the screw cap 7b of the specimen container 7 and prevent the biohazard.

### REFERENCE SIGNS LIST

2: room (work room)
7: specimen container
7a: main body (specimen container main body)
7b: screw cap (specimen container lid)
7d: identification information (first identification information)
8: microtube (dispensing container)
8a: main body (dispensing container main body)
8b: lid unit (dispensing container lid)
8c: connector
8f: identification information (second identification information)
10: robot
11: body
12: base
20: first robot arm (robot arm unit)
22: hand
23: first chuck
24: second chuck
30: second robot arm (robot arm unit)
33: dispenser
40: safety cabinet (specimen processing cabinet)
42: workbench
51: dispensing tip rack
52: dispensing tip disposal unit
60: lid opener/closer
61: holding rotator
70: placing table
80a: identification information reading unit (first identification information reader)
80b: identification information reading unit (second identification information reader)
90: block (lid closer)
90a: upper surface (abutment portion)
90b: side surface (abutment portion)
90c: inclined surface (abutment portion)
90d: lower surface (abutment portion)
91: command unit
100: dispensing system
110: plate (dispensing container)
210: robot

1. A dispensing system of individually dispensing a specimen accommodated in a specimen container into a dispensing container inside a specimen processing cabinet, the dispensing system comprising:
a robot including a first robot arm provided with a hand for holding the specimen container, a second robot arm provided with a dispenser for dispensing the specimen accommodated in the specimen container into the dispensing container, and a body that supports the first robot arm and the second robot arm,
wherein in a state where at least the body of the robot is arranged outside the specimen processing cabinet and the hand provided in the first robot arm and the dispenser provided in the second robot arm are inserted into the specimen processing cabinet, the dispenser dispenses the specimen accommodated in the specimen container held by the hand into the dispensing container.

2. The dispensing system according to claim 1,
wherein the specimen container includes a specimen container main body and a specimen container lid that covers an opening of the specimen container main body, and
the robot performs an operation of opening the specimen container lid of the specimen container inside the specimen processing cabinet.

3. The dispensing system according to claim 2,
wherein the robot performs an operation of closing the opened specimen container lid of the specimen container inside the specimen processing cabinet.

4. The dispensing system according to claim 3, further comprising:
a lid opener/closer that is arranged inside the specimen processing cabinet and opens or closes the specimen container lid of the specimen container holding the specimen container main body by the hand of the first robot arm in cooperation with the hand of the first robot arm.

5. The dispensing system according to claim 4,
wherein the specimen container lid includes a screw cap that is attached to or removed from the specimen container main body by rotating with respect to the specimen container main body, and
the lid opener/closer includes a holding rotator that holds and rotates the screw cap.

6. The dispensing system according to claim 5,
wherein the holding rotator moves so that the hand of the first robot arm is separated from the holding rotator while holding and rotating the screw cap, and thus, the screw cap is removed from the specimen container main body.

7. The dispensing system according to claim 2,
wherein the robot opens or closes the specimen container lid of the specimen container inside the specimen processing cabinet by using the hand of the first robot arm.

8. The dispensing system according to claim 1,
wherein a plurality of the specimen containers are provided, and
the dispensing system further comprises a rotatable placing table having a disk shape which is arranged inside the specimen processing cabinet and in which at least the plurality of specimen containers are placed in a circumferential shape.

9. The dispensing system according to claim 8,
wherein a plurality of the dispensing containers are provided, and
both the plurality of specimen containers and the plurality of dispensing containers are placed in a circumferential shape on the placing table having a disk shape.

10. The dispensing system according to claim 8,
wherein the hand of the first robot arm rotates the placing table having a disk shape by a predetermined angle.

11. The dispensing system according to claim 1, further comprising:
a first identification information reader for reading first identification information attached to the specimen container,
wherein the hand of the first robot arm moves the specimen container held by the hand to a position at which the first identification information reader reads the first identification information, and thus, the first identification information reader reads the first identification information attached to the specimen container.

12. The dispensing system according to claim 11, further comprising:
a second identification information reader that reads second identification information attached to the dispensing container,
wherein the hand of the first robot arm is configured to hold the specimen container and the dispensing container, and
the hand of the first robot arm moves the specimen container and the dispensing container held by the hand to a position at which the first identification information reader and the second identification information reader read the first identification information and the second identification information, and thus, the first identification information reader and the second identification information reader read the first identification information attached to the specimen container and the second identification information attached to the dispensing container.

13. The dispensing system according to claim 1,
wherein the hand of the first robot arm includes a first chuck that holds the specimen container and a second chuck that holds the dispensing container, and
inside the specimen processing cabinet, the dispenser of the robot dispenses the specimen accommodated in the specimen container held by the first chuck of the hand into the dispensing container held by the second chuck.

14. The dispensing system according to claim 1,
wherein the dispensing container includes a dispensing container main body and a dispensing container lid connected to the dispensing container main body via a connector, and
the robot performs an operation of closing the dispensing container lid of the dispensing container after the specimen accommodated in the specimen container is dispensed inside the specimen processing cabinet.

15. The dispensing system according to claim 14, further comprising:
a lid closer which is arranged inside the specimen processing cabinet and closes the dispensing container lid of the dispensing container after the specimen accommodated in the specimen container is dispensed in cooperation with the hand of the first robot arm.

16. The dispensing system according to claim 15,
wherein the lid closer includes an abutment portion on which the dispensing container lid of the dispensing container abuts, and
the robot moves the dispensing container held by the hand by the first robot arm relative to the abutment portion, the dispensing container lid connected to the dispensing container main body via the connector abuts on the abutment portion, and thus, the dispensing container lid is closed.

17. The dispensing system according to claim 1, further comprising:
a workbench which is arranged in the specimen processing cabinet and on which the specimen container is placed; and
a base on which the robot is placed,
wherein the workbench and the base are integrally configured.

18. The dispensing system according to claim 1,
wherein in a state where the body of the robot is arranged outside the specimen processing cabinet and at least one of the first robot arm in which the hand is provided and the second robot arm in which the dispenser is provided is inserted into the specimen processing cabinet, the robot dispenses the specimen accommodated in the specimen container into the dispensing container by the hand and the dispenser.

19-24. (canceled)

25. A robot individually dispensing a specimen accommodated in a specimen container into a dispensing container inside a specimen processing cabinet, the robot comprising:
a first robot arm provided with a hand for holding the specimen container;
a second robot arm provided with a dispenser for dispensing the specimen accommodated in the specimen container into the dispensing container; and
a body that supports the first robot arm and the second robot arm,
wherein in a state where at least the body of the robot is arranged outside the specimen processing cabinet and the hand provided in the first robot arm and the dispenser provided in the second robot arm are inserted into the specimen processing cabinet, the dispenser dispenses the specimen accommodated in the specimen container held by the hand into the dispensing container.

26. A dispensing method of dispensing a specimen accommodated in a specimen container into a dispensing container by a hand of at least one robot arm inserted in a specimen processing cabinet, the dispensing method comprising:
a step of holding the specimen container by the hand of the at least one robot arm; and
a step of dispensing the specimen accommodated in the specimen container into the dispensing container by the hand of the at least one robot arm.

27-33. (canceled)
